(19) United States
(12) Patent Application Publication
(10) Pub. No.: US 2012/0123006 A1
(43) Pub. Date: May 17, 2012

(54) RESIN COMPOSITION FOR CROSSLINKING/FOAM MOLDING, CROSSLINKED MOLDED FOAM, MEMBER FOR FOOTWEAR, AND FOOTWEAR

(75) Inventors: Katsuhiro Yamada, Chiba (JP); Yoshinobu Nozue, Ichihara (JP)

(73) Assignee: SUMITOMO CHEMICAL COMPANY, LIMITED, Tokyo (JP)

(21) Appl. No.: 13/322,356

(22) PCT Filed: May 25, 2010
(86) PCT No.: PCT/JP2010/059165

§ 371 Date: Jan. 31, 2012

(30) Foreign Application Priority Data
May 29, 2009 (JP) 2009-130141

(51) Int. Cl. C08F 210/02

(52) U.S. Cl. 521/144

(57) ABSTRACT

Disclosed is a resin composition for crosslinking/foam molding which comprises a resin ingredient, a blowing agent, and a crosslinking agent, wherein the resin ingredient is an ethylene/α-olefin copolymer that comprises monomer units based on ethylene and monomer units based on an α-olefin having 3 to 20 carbon atoms and satisfies all of the following: (1) to have a density of 860-950 kg/m³, (2) to have a melt flow rate (MFR) of 0.01-10 g/10 min, (3) to have a ratio of weight-average molecular weight (Mw) to number-average molecular weight (Mn), Mw/Mn, of 5.5-30, (4) to have a ratio of Z-average molecular weight (Mz) to weight-average molecular weight (Mw), Mz/Mw, of 2-4, and (5) to have a melt tension (MT) of 8 cN or higher.

### TECHNICAL FIELD

The present invention relates to a resin composition for cross-linking expansion molding, a cross-linked expansion molded article, a footwear member and footwear.

### BACKGROUND ART

Cross-linked expansion molded articles comprising polyethylene resins are used in a wide range as convenience goods, flooring materials, sound insulators, heat insulators, footwear members (outer soles (bottom soles), midsoles (top soles), insoles (interior bottom), etc.), and so on. Particularly, for example, cross-linked expansion molded articles obtained by cross-linking foaming an ethylene-vinyl acetate copolymer (see, e.g., PATENT DOCUMENT 1) are known as the cross-linked expansion molded articles. Moreover, cross-linked expansion molded articles are also known, which are obtained using an ethylene-α-olefin copolymer obtained by copolymerizing ethylene with an α-olefin using a polymerization catalyst obtained by bringing a contacted product between triisobutylaluminum and racemic ethylene bis(1-indenyl)zirconium diphenoxide into contact with a promoter carrier prepared by the reaction of diethylzinc, pentafluorophenol, water, silica and hexamethyldisilazane (see e.g., PATENT DOCUMENT 2).
[PATENT DOCUMENT 1] JP 3-2657 B
[PATENT DOCUMENT 2] JP 2005-314638 A

When a cross-linked expansion molded article is particularly used as a footwear member such as outer soles, midsoles or insoles, it is required to have high fatigue resistance. For conventional cross-linked expansion molded articles, it has been required to further improve performance in fatigue resistance.

### DISCLOSURE OF THE INVENTION

The present inventors have conducted diligent studies to solve the problem and consequently found that a cross-linked expansion molded article, a compressed cross-linked expansion molded article, a footwear member and footwear having excellent fatigue resistance are obtained by using a resin composition for cross-linking expansion molding having particular composition.

Specifically, a first aspect of the present invention relates to a resin composition for cross-linking expansion molding comprising a resin component, a foaming agent and a cross-linking agent, wherein the resin composition comprises, as the resin component, an ethylene-α-olefin copolymer that comprises monomer units derived from ethylene and monomer units derived from an α-olefin having 3 to 20 carbon atoms and that satisfies all the following conditions (1) to (5):

(1) the density is 860 to 950 kg/m³,

(2) the melt flow rate (MFR) is 0.01 to 10 g/10 min,

(3) the ratio of the weight-average molecular weight to the number-average molecular weight (Mw/Mn) is 5.5 to 30,

(4) the ratio of the z-average molecular weight to the weight-average molecular weight (Mz/Mw) is 2 to 4, and

(5) the melt tension (MT) is 8 cN or more.

A second aspect of the present invention relates to a cross-linked expansion molded article obtained by cross-linking expansion molding the resin composition for cross-linking expansion molding.

A third aspect of the present invention relates to a compressed cross-linked expansion molded article obtained by compressing the cross-linked expansion molded article.

A fourth aspect of the present invention relates to a footwear member having a layer of the cross-linked expansion molded article or the compressed cross-linked expansion molded article.

A fifth aspect of the present invention relates to footwear comprising the footwear member.

### MODE FOR CARRYING OUT THE INVENTION

A resin composition for cross-linking expansion molding of the present invention includes a resin composition for cross-linking expansion molding comprising a resin component, a foaming agent and a cross-linking agent. The resin composition comprises, as the resin component, an ethylene-α-olefin copolymer that comprises monomer units derived from ethylene and monomer units derived from an α-olefin having 3 to 20 carbon atoms and that satisfies all the following conditions (1) to (5):

(1) the density is 860 to 950 kg/m³,

(2) the melt flow rate (MFR) is 0.01 to 10 g/10 min,

(3) the ratio of the weight-average molecular weight to the number-average molecular weight (Mw/Mn) is 5.5 to 30,

(4) the ratio of the z-average molecular weight to the weight-average molecular weight (Mz/Mw) is 2 to 4, and

(5) the melt tension (MT) is 8 cN or more.

The ethylene-α-olefin copolymer according to the present invention is an ethylene-α-olefin copolymer comprising monomer units derived from ethylene and monomer units derived from an α-olefin having 3 to 20 carbon atoms. Examples of the α-olefin include propylene, 1-butene, 1-pentene, 1-hexene, 1-heptene, 1-octene, 1-nonene, 1-decene, 1-dodecene, 4-methyl-1-pentene and 4-methyl-1-hexene. They may be used alone or in combination of two or more thereof. The α-olefin is preferably 1-butene, 1-hexene, 4-methyl-1-pentene or 1-octene. When a cross-linked expansion molded article of the present invention is used as a shoe sole member such as a midsole, 1-hexene, 4-methyl-1-pentene or 1-octene is preferable from the viewpoint of enhancing the strength of the cross-linked expansion molded article.

The content of the monomer units derived from ethylene in the ethylene-α-olefin copolymer according to the present invention is usually 50 to 99.5% by weight relative to the total weight (100% by weight) of the ethylene-α-olefin copolymer. Moreover, the content of the monomer units derived from an α-olefin is usually 0.5 to 50% by weight relative to the total weight (100% by weight) of the ethylene-α-olefin copolymer.

The density of the ethylene-α-olefin copolymer according to the present invention is 860 to 950 kg/m³ (condition (1)). The density is preferably 865 kg/m³ or more, more preferably 870 kg/m³ or more, still more preferably 900 kg/m³ or more, from the viewpoint of enhancing the rigidity of the cross-linked expansion molded article. Moreover, the density is preferably 920 kg/m³ or less from the viewpoint of enhancing the lightness of the cross-linked expansion molded article. The density is measured according to the immersion method prescribed in JIS K7112-1980 after conducting annealing as prescribed in JIS K6760-1995.

The melt flow rate (hereinafter, also referred to as “MFR”) of the ethylene-α-olefin copolymer according to the present invention is 0.01 to 10 g/10 min (condition (2)). The melt flow rate (MFR) is preferably 0.2 g/10 min or more, because foam having a high expansion ratio is obtained and foam moldability is also improved. Moreover, the MFR is preferably 5 g/10 min or less, more preferably 3 g/10 min or less, because the obtained cross-linked expansion molded article is excellent in strength. The MFR is measured by the A method according to JIS K7210-1995 under conditions involving a temperature of 190° C. and a load of 21.18 N. In the measurement of the melt flow rate, the ethylene-α-olefin copolymer mixed in advance with approximately 1,000 ppm antioxidant is usually used. Moreover, the melt flow rate of the ethylene-α-olefin copolymer can be changed by varying, for example, a hydrogen concentration or a polymerization temperature, in a production method described later. The melt flow rate of the ethylene-α-olefin copolymer is increased by increasing the hydrogen concentration or the polymerization temperature.

The ratio of the weight-average molecular weight (hereinafter, also referred to as “Mw”) to the number-average molecular weight (hereinafter, also referred to as “Mn”) (hereinafter, this ratio is also referred to as “Mw/Mn”) of the ethylene-α-olefin copolymer according to the present invention is 5.5 to 30 (condition (3)). The ratio of the z-average molecular weight (hereinafter, also referred to as “Mz”) to the weight-average molecular weight (Mw) (hereinafter, this ratio is also referred to as “Mz/Mw”) is 2 to 4 (condition (4)). If Mw/Mn is too small or Mz/Mw is too large, cross-linking expansion molding may become unstable, easily producing cracks in the resulting foam. Mw/Mn is preferably 6 or more, and Mz/Mw is preferably 4.5 or less. If Mw/Mn is too large or Mz/Mw is too small, the obtained cross-linked expansion molded article may have low mechanical strength. Mw/Mn is preferably 25 or less, more preferably 20 or less, and Mz/Mw is preferably 2 or more. The Mw/Mn and the Mz/Mw are determined by measuring the number-average molecular weight (Mn), the weight-average molecular weight (Mw) and the z-average molecular weight (Mz) by gel permeation chromatography (GPC) and dividing Mw by Mn and Mz by Mw. Moreover, the Mw/Mn can be changed by varying, for example, a hydrogen concentration or a polymerization temperature, in a production method described later. The Mw/Mn of the ethylene-α-olefin copolymer is increased by increasing the hydrogen concentration or the polymerization temperature. The Mz/Mw can be changed by varying, for example, the proportions of a transition metal compound (A1) and a transition metal compound (A2) used, in a production method described later. The Mz/Mw of the ethylene-α-olefin copolymer is decreased by decreasing the proportion of the transition metal compound (A2) used.

Mz/Mw represents the molecular weight distribution of high-molecular-weight components. Mz/Mw smaller than Mw/Mn means that the molecular weight distribution of high-molecular-weight components is narrow and that the proportion of very high-molecular-weight components is small. Mz/Mw larger than Mw/Mn means that the molecular weight distribution of high-molecular-weight components is wide and that the proportion of very high-molecular-weight components is large. Preferably, (Mw/Mn)-(Mz/Mw) is 1 or more, more preferably 2 or more.

The activation energy of flow (hereinafter, also referred to as “Ea”) of the ethylene-α-olefin copolymer according to the present invention is preferably 60 kJ/mol or more, more preferably 70 kJ/mol or more, from the viewpoint of suppressing heat generation during the preparation of the composition using a kneader such as a Banbury mixer and thereby more suppressing unnecessary decomposition of additives. Moreover, the activation energy of flow is preferably 150 kJ/mol or less, more preferably 140 kJ/mol or less, still more preferably 130 kJ/mol or less, from the viewpoint of enhancing foaming stability during cross-linking expansion molding. Moreover, the activation energy of flow can be changed by varying, for example, the proportions of a transition metal compound (A1) and a transition metal compound (A2) used, in a production method described later. The Ea of the ethylene-α-olefin copolymer is increased by increasing the proportion of the transition metal compound (A2) used.

The activation energy of flow (Ea) is a numeric value that is calculated, based on the time-temperature superposition principle, by the Arrhenius equation from a shift factor (a_{T}) in preparing a master curve which shows the angular frequency (unit: rad/sec) dependence of melt complex viscosity (unit: Pa·sec) at 190° C. This value is determined by the following method: the melt complex viscosity-angular frequency curve (unit of melt complex viscosity: Pa·sec, unit of angular frequency: rad/sec) of the ethylene-α-olefin copolymer is obtained for each temperature (T, unit: ° C.) of 130° C., 150° C., 170° C. and 190° C., and a shift factor (a_{T}) at each temperature (T) is determined by superposing each melt complex viscosity-angular frequency curve at each temperature (T) onto the melt complex viscosity-angular frequency curve of the ethylene copolymer at 190° C., based on the time-temperature superposition principle. From each temperature (T) and the shift factor (a_{T}) at each temperature (T), a linear approximate equation (the following equation (I)) of [ln(a_{T})] and [1/(T+273.16)] is calculated by the method of least squares. Next, the Ea is determined from a slope m in the linear approximate equation and the following equation (II):

ln(a_{T})=m(1/(T+273.16))+n (I)

Ea=|0.008314×m| (II)

a_{T}: shift factor

Ea: activation energy of flow (unit: kJ/mol)

T: temperature (unit: ° C.)

The calculation may be performed using commercially available calculation software. Examples of the calculation software include Rhios V.4.4.4 manufactured by Rheometrics, Inc. The shift factor (a_{T}) is the amount of shift when the log-log curve of melt complex viscosity-angular frequency at each temperature (T) is shifted in the axial direction of log (Y)=−log (X) (wherein the Y axis represents melt complex viscosity, and the X axis represents angular frequency) to superpose it onto the melt complex viscosity-angular frequency curve at 190° C. In the superposition, each log-log curve of melt complex viscosity-angular frequency at each temperature (T) is shifted by a_{T} times in angular frequency and by 1/a_{T} times in melt complex viscosity. Moreover, the coefficient of correlation for determining the equation (I) from the values at four temperatures, i.e., 130° C., 150° C., 170° C. and 190° C. by the method of least squares is usually 0.99 or more.

The measurement of the melt complex viscosity-angular frequency curve is performed using a viscoelasticity measurement apparatus (e.g., Rheometrics Mechanical Spectrometer RMS-800 manufactured by Rheometrics, Inc.) usually under conditions involving geometry: parallel plate, plate diameter: 25 mm, plate space: 1.5 to 2 mm, strain: 5% and angular frequency: 0.1 to 100 rad/sec. The measurement is performed in a nitrogen atmosphere. Moreover, it is preferable that a measurement sample be mixed in advance with an appropriate amount (e.g., 1,000 ppm) of an antioxidant.

The melt flow rate ratio (hereinafter, also referred to as “MFRR”) of the ethylene-α-olefin copolymer of the present invention is preferably 60 or more, and 70 or more, 80 or more, and 90 or more with increasing preference from the viewpoint of further reducing extrusion load during molding. Moreover, the melt flow rate ratio (MFRR) is preferably 200 or less, more preferably 180 or less, from the viewpoint of more enhancing the mechanical strength of the obtained molded article. The MFRR is a value that is determined by measuring a melt flow rate by the method prescribed in JIS K7210-1995 under conditions involving a load of 211.82 N and a temperature of 190° C. (hereinafter, also referred to as “H-MFR”), and dividing the H-MFR by a melt flow rate (MFR) measured by the method prescribed in JIS K7210-1995 under conditions involving a load of 21.18 N and a temperature of 190° C. Moreover, the MFRR can be changed by varying, for example, a hydrogen concentration, in a production method described later. The MFRR of the ethylene-α-olefin copolymer is decreased by increasing the hydrogen concentration.

The melt tension (hereinafter, also referred to as “MT”) of the ethylene-α-olefin copolymer of the present invention is 8 cN or more (condition (5)). If the melt tension is too small, foam bursts may easily occur during cross-linking expansion molding, impairing the appearance of the resulting foam.

The melt tension is preferably 10 cN or more, and 12 cN or more, 15 cN or more, 17 cN or more, and 18 cN or more, with increasing preference. Moreover, the melt tension is preferably 50 cN or less, more preferably 40 cN or less, from the viewpoint of enhancing the expansion ratio of the cross-linked expansion molded article. The melt tension is measured as a tension required for drawing, at an upward drawing rate of 6.3 (m/min)/min, a filament form of an extruded melted ethylene-α-olefin copolymer obtained by extruding the molten ethylene-α-olefin copolymer from an orifice of 2.095 mm in diameter and 8 mm in length at a temperature of 190° C. and an extrusion rate of 0.32 g/min. The melt tension is the maximum tension in a period from the start of drawing to the break of the filament form of the ethylene-α-olefin copolymer. Moreover, the melt tension can be changed by varying, for example, the pressure of ethylene during polymerization, in a production method described later. The melt tension of the ethylene-α-olefin copolymer is increased by decreasing the pressure of ethylene during polymerization. Moreover, the melt tension can be changed by varying, for example, the proportions of a transition metal compound (A1) and a transition metal compound (A2) used, in a production method described later. The melt tension of the ethylene-α-olefin copolymer is increased by increasing the proportion of the transition metal compound (A2) used.

Examples of methods for producing the ethylene-α-olefin copolymer of the present invention can include a method comprising copolymerizing ethylene and an α-olefin in the presence of a polymerization catalyst obtained by bringing a transition metal compound (A1) represented by the following general formula (1), a transition metal compound (A2) represented by the following general formula (3), and a promoter component (B) described later into contact with each other at a molar ratio ((A1)/(A2)) of the transition metal compound (A1) to the transition metal compound (A2) of 1 to 40. The (A1)/(A2) is preferably 3 or more, more preferably 5 or more. Moreover, the (A1)/(A2) is preferably 30 or less, more preferably 20 or less.

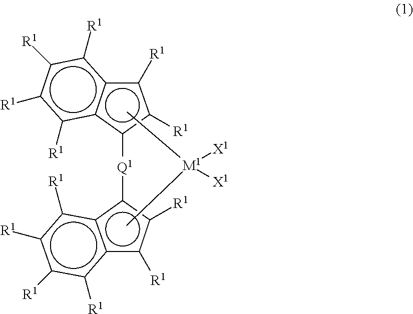

wherein M¹ represents a transition metal atom in group 4 of the periodic table of elements; X¹ and R¹ each independently represent a hydrogen atom, a halogen atom, a hydrocarbyl group having 1 to 20 carbon atoms which may be substituted, a hydrocarbyloxy group having 1 to 20 carbon atoms which may be substituted, a substituted silyl group having 1 to 20 carbon atoms or a substituted amino group having 1 to 20 carbon atoms; the X¹ groups may be the same or different; the R¹ groups may be the same or different; and Q¹ represents a bridging group represented by the following general formula (2):

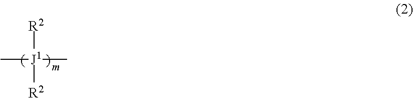

wherein m represents an integer of 1 to 5; J¹ represents an atom in group 14 of the periodic table of elements; R² represents a hydrogen atom, a halogen atom, a hydrocarbyl group having 1 to 20 carbon atoms which may be substituted, a hydrocarbyloxy group having 1 to 20 carbon atoms which may be substituted, a substituted silyl group having 1 to 20 carbon atoms or a substituted amino group having 1 to 20 carbon atoms; and the R² groups may be the same or different.

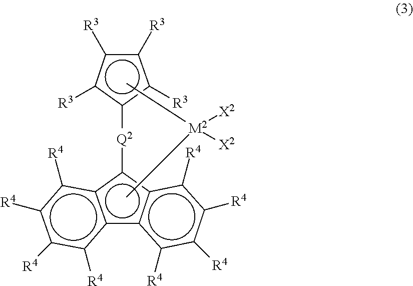

wherein M² represents a transition metal atom in group 4 of the periodic table of elements; X², R³ and R⁴ each independently represent a hydrogen atom, a halogen atom, a hydrocarbyl group having 1 to 20 carbon atoms which may be substituted, a hydrocarbyloxy group having 1 to 20 carbon atoms which may be substituted, a substituted silyl group having 1 to 20 carbon atoms or a substituted amino group having 1 to 20 carbon atoms; the X² groups may be the same or different; the R³ groups may be the same or different; the R⁴ groups may be the same or different; and Q² represents a bridging group represented by the following general formula (4):

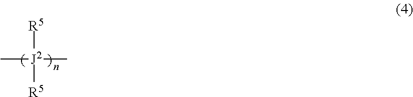

wherein n represents an integer of 1 to 5; J² represents an atom in group 14 of the periodic table of elements; R⁵ represents a hydrogen atom, a halogen atom, a hydrocarbyl group having 1 to 20 carbon atoms which may be substituted, a hydrocarbyloxy group having 1 to 20 carbon atoms which may be substituted, a substituted silyl group having 1 to 20 carbon atoms or a substituted amino group having 1 to 20 carbon atoms; and the R⁵ groups may be the same or different.

M¹ in the general formula (1) and M² in the general formula (3) respectively represent a transition metal atom in group 4 of the periodic table of elements. Examples thereof include a titanium atom, a zirconium atom and a hafnium atom.

X¹ and R¹ in the general formula (1) and X², R³ and R⁴ in the general formula (3) each independently represent a hydrogen atom, a halogen atom, a hydrocarbyl group having 1 to 20 carbon atoms which may be substituted, a hydrocarbyloxy group having 1 to 20 carbon atoms which may be substituted, a substituted silyl group having 1 to 20 carbon atoms or a substituted amino group having 1 to 20 carbon atoms; the X¹ groups may be the same or different; the R¹ groups may be the same or different; the X² groups may be the same or different; the R³ groups may be the same or different; and the R⁴ may be the same or different.

Examples of the halogen atom represented by X¹, R¹⁵, X², R³ or R⁴ include a fluorine atom, a chlorine atom, a bromine atom and an iodine atom.

Examples of the hydrocarbyl group having 1 to 20 carbon atoms which may be substituted, represented by X¹, R¹, X², R³ or R⁴ include an alkyl group having 1 to 20 carbon atoms, an alkyl halide group having 1 to 20 carbon atoms, an aralkyl group having 7 to 20 carbon atoms and an aryl group having 6 to 20 carbon atoms.

Examples of the alkyl group having 1 to 20 carbon atoms include a methyl group, an ethyl group, a n-propyl group, an isopropyl group, a n-butyl group, a sec-butyl group, a tert-butyl group, a n-pentyl group, a neopentyl group, an isopentyl group, a n-hexyl group, a n-heptyl group, a n-octyl group, a n-decyl group, a n-nonyl group, a n-decyl group, a n-dodecyl group, a n-dodecyl group, a n-tridecyl group, a n-tetradecyl group, a n-pentadecyl group, a n-hexadecyl group, a n-heptadecyl group, a n-octadecyl group, a n-nonadecyl group and a n-eicosyl group.

Examples of the alkyl halide group having 1 to 20 carbon atoms include a fluoromethyl group, a difluoromethyl group, a trifluoromethyl group, a chloromethyl group, a dichloromethyl group, a trichloromethyl group, a bromomethyl group, a dibromomethyl group, a tribromomethyl group, an iodomethyl group, a diiodomethyl group, a triiodomethyl group, a fluoroethyl group, a difluoroethyl group, a trifluoroethyl group, a tetrafluoroethyl group, a pentafluoroethyl group, a chloroethyl group, a dichloroethyl group, a trichloroethyl group, a tetrachloroethyl group, a pentachloroethyl group, a bromoethyl group, a dibromoethyl group, a tribromoethyl group, a tetrabromoethyl group, a pentabromoethyl group, a perfluoropropyl group, a perfluorobutyl group, a perfluoropentyl group, a perfluorohexyl group, a perfluorooctyl group, a perfluorododecyl group, a perfluoropentadecyl group, a perfluoroeicosyl group, a perchloropropyl group, a perchlorobutyl group, a perchloropentyl group, a perchlorohexyl group, a perchlorooctyl group, a perchlorododecyl group, a perchloropentadecyl group, a perchloroeicosyl group, a perbromopropyl group, a perbromobutyl group, a perbromopentyl group, a perbromohexyl group, a perbromooctyl group, a perbromododecyl group, a perbromopentadecyl group and a perbromoeicosyl group.

Examples of the aralkyl group having 7 to 20 carbon atoms include a benzyl group, a (2-methylphenyl)methyl group, a (3-methylphenyl)methyl group, a (4-methylphenyl)methyl group, a (2,3-dimethylphenyl)methyl group, a (2,4-dimethylphenyl)methyl group, a (2,5-dimethylphenyl)methyl group, a (2,6-dimethylphenyl)methyl group, a (3,4-dimethylphenyl)methyl group, a (4,6-dimethylphenyl)methyl group, a (2,3,4-trimethylphenyl)methyl group, a (2,3,5-trimethylphenyl)methyl group, a (2,3,6-trimethylphenyl)methyl group, a (3,4,5-trimethylphenyl)methyl group, a (2,4,6-trimethylphenyl)methyl group, a (2,3,4,5-tetramethylphenyl)methyl group, a (2,3,4,6-tetramethylphenyl)methyl group, a (2,3,5,6-tetramethylphenyl)methyl group, a (pentamethylphenyl)methyl group, an (ethylphenyl)methyl group, a (n-propylphenyl)methyl group, an (isopropylphenyl)methyl group, a (n-butylphenyl)methyl group, a (sec-butylphenyl)methyl group, a (tert-butylphenyl)methyl group, a (n-pentylphenyl)methyl group, a (neopentylphenyl)methyl group, a (n-hexylphenyl)methyl group, a (n-octylphenyl)methyl group, a (n-decylphenyl)methyl group, a (n-decylphenyl)methyl group, a (n-tetradecylphenyl)methyl group, a naphthylmethyl group, an anthracenylmethyl group, a phenylethyl group, a phenylpropyl group, a phenylbutyl group, a diphenylmethyl group, a diphenylethyl group, a diphenylpropyl group and a diphenylbutyl group. Alternative examples thereof include aralkyl halide groups in which these aralkyl groups are substituted by a halogen atom such as a fluorine atom, a chlorine atom, a bromine atom or an iodine atom.

Examples of the aryl group having 6 to 20 carbon atoms include a phenyl group, a 2-tolyl group, a 3-tolyl group, a 4-tolyl group, a 2,3-xylyl group, a 2,4-xylyl group, a 2,5-xylyl group, a 2,6-xylyl group, a 3,4-xylyl group, a 3,5-xylyl group, a 2,3,4-trimethylphenyl group, a 2,3,5-trimethylphenyl group, a 2,3,6-trimethylphenyl group, a 2,4,6-trimethylphenyl group, a 3,4,5-trimethylphenyl group, a 2,3,4,5-tetramethylphenyl group, a 2,3,4,6-tetramethylphenyl group, a 2,3,5,6-tetramethylphenyl group, a pentamethylphenyl group, an ethylphenyl group, a diethylphenyl group, a triethylphenyl group, a n-propylphenyl group, an isopropylphenyl group, a n-butylphenyl group, a sec-butylphenyl group, a tert-butylphenyl group, a n-pentylphenyl group, a neopentylphenyl group, a n-hexylphenyl group, a n-octylphenyl group, a n-decylphenyl group, a n-dodecylphenyl group, a n-tetradecylphenyl group, a naphthyl group and an anthracenyl group. Alternative examples thereof include aryl halide groups in which these aryl groups are substituted by a halogen atom such as a fluorine atom, a chlorine atom, a bromine atom or an iodine atom.

Moreover, examples of the hydrocarbyl group having 1 to 20 carbon atoms which may be substituted include a hydrocarbyl group substituted by a substituted silyl group, a hydrocarbyl group substituted by a substituted amino group and a hydrocarbyl group substituted by a hydrocarbyloxy group.

Examples of the hydrocarbyl group substituted by a substituted silyl group include a trimethylsilylmethyl group, a trimethylsilylethyl group, a trimethylsilylpropyl group, a trimethylsilylbutyl group, a trimethylsilylphenyl group, a bis(trimethylsilyl)methyl group, a bis(trimethylsilyl)ethyl group, a bis(trimethylsilyl)propyl group, a bis(trimethylsilyl)butyl group, a bis(trimethylsilyl)phenyl group and a triphenylsilylmethyl group.

Examples of the hydrocarbyl group substituted by a substituted amino group include a dimethylaminomethyl group, a dimethylaminoethyl group, a dimethylaminopropyl group, a dimethylaminobutyl group, a dimethylaminophenyl group, a bis(dimethylamino)methyl group, a bis(dimethylamino)ethyl group, a bis(dimethylamino)propyl group, a bis(dimethylamino)butyl group, a bis(dimethylamino)phenyl group, a phenylaminomethyl group, a diphenylaminomethyl group and a diphenylaminophenyl group.

Examples of the hydrocarbyl group substituted by a hydrocarbyloxy group include a methoxymethyl group, an ethoxymethyl group, a n-propoxymethyl group, an isopropoxymethyl group, a n-butoxymethyl group, a sec-butoxymethyl group, a tert-butoxymethyl group, a phenoxymethyl group, a methoxyethyl group, an ethoxyethyl group, a n-propoxyethyl group, an isopropoxyethyl group, a n-butoxyethyl group, a sec-butoxyethyl group, a tert-butoxyethyl group, a phenoxyethyl group, a methoxy-n-propyl group, an ethoxy-n-propyl group, a n-propoxy-n-propyl group, an isopropoxy-n-propyl group, a n-butoxy-n-propyl group, a sec-butoxy-n-propyl group, a tert-butoxy-n-propyl group, a phenoxy-n-propyl group, a methoxyisopropyl group, an ethoxyisopropyl group, a n-propoxyisopropyl group, an isopropoxyisopropyl group, a n-butoxyisopropyl group, a sec-butoxyisopropyl group, a tert-butoxyisopropyl group, a phenoxyisopropyl group, a methoxyphenyl group, an ethoxyphenyl group, a n-propoxyphenyl group, an isopropoxyphenyl group, a n-butoxyphenyl group, a sec-butoxyphenyl group, a tert-butoxyphenyl group and a phenoxyphenyl group.

Examples of the hydrocarbyloxy group having 1 to 20 carbon atoms which may be substituted, represented by X¹, R¹, X², R³ or R⁴ include an alkoxy group having 1 to 20 carbon atoms, an aralkyloxy group having 7 to 20 carbon atoms and an aryloxy group having 6 to 20 carbon atoms.

Examples of the alkoxy group having 1 to 20 carbon atoms include a methoxy group, an ethoxy group, a n-propoxy group, an isopropoxy group, a n-butoxy group, a sec-butoxy group, a tert-butoxy group, a n-pentyloxy group, a neopentyloxy group, a n-hexyloxy group, a n-octyloxy group, a n-nonyloxy group, a n-decyloxy group, a n-undecyloxy group, a n-dodecyloxy group, a n-tridecyloxy group, a n-tetradecyloxy group, a n-pentadecyloxy group, a n-hexadecyloxy group, a n-heptadecyloxy group, a n-heptadecyloxy group, a n-octadecyloxy group, a n-nonadecyloxy group and a n-eicosyloxy group. Alternative examples thereof include alkoxy halide groups in which these alkoxy groups are substituted by a halogen atom such as a fluorine atom, a chlorine atom, a bromine atom or an iodine atom.

Examples of the aralkyloxy group having 7 to 20 carbon atoms include a benzyloxy group, a (2-methylphenyl)methoxy group, a (3-methylphenyl)methoxy group, a (4-methylphenyl)methoxy group, a (2,3-dimethylphenyl)methoxy group, a (2,4-dimethylphenyl)methoxy group, a (2,5-dimethylphenyl)methoxy group, a (2,6-dimethylphenyl)methoxy group, a (3,4-dimethylphenyl)methoxy group, a (3,5-dimethylphenyl)methoxy group, a (2,3,4-trimethylphenyl)methoxy group, a (2,3,5-trimethylphenyl)methoxy group, a (2,3,6-trimethylphenyl)methoxy group, a (2,4,5-trimethylphenyl)methoxy group, a (2,4,6-trimethylphenyl)methoxy group, a (3,4,5-trimethylphenyl)methoxy group, a (2,3,4,5-tetramethylphenyl)methoxy group, a (2,3,4,6-tetramethylphenyl)methoxy group, a (2,3,5,6-tetramethylphenyl)methoxy group, a (pentamethylphenyl)methoxy group, an (ethylphenyl)methoxy group, a (n-propylphenyl)methoxy group, an (isopropylphenyl)methoxy group, a (n-butylphenyl)methoxy group, a (sec-butylphenyl)methoxy group, a (tert-butylphenyl)methoxy group, a (n-hexylphenyl)methoxy group, a (n-octylphenyl)methoxy group, a (n-decylphenyl)methoxy group, a (n-tetradecylphenyl)methoxy group, a naphthylmethoxy group and an anthracenylmethoxy group. Alternative examples thereof include aralkyloxy halide groups in which these aralkyloxy groups are substituted by a halogen atom such as a fluorine atom, a chlorine atom, a bromine atom or an iodine atom.

Examples of the aryloxy group having 6 to 20 carbon atoms include a phenoxy group, a 2-methylphenoxy group, a 3-methylphenoxy group, a 4-methylphenoxy group, a 2,3-dimethylphenoxy group, a 2,4-dimethylphenoxy group, a 2,5-dimethylphenoxy group, a 2,6-dimethylphenoxy group, a 3,4-dimethylphenoxy group, a 3,5-dimethylphenoxy group, a 2,3,4-trimethylphenoxy group, a 2,3,5-trimethylphenoxy group, a 2,3,6-trimethylphenoxy group, a 2,4,5-trimethylphenoxy group, a 2,4,6-trimethylphenoxy group, a 3,4,5-trimethylphenoxy group, a 2,3,4,5-tetramethylphenoxy group, a 2,3,4,6-tetramethylphenoxy group, a 2,3,5,6-tetramethylphenoxy group, a pentamethylphenoxy group, an ethylphenoxy group, a n-propylphenoxy group, an isopropylphenoxy group, a n-butylphenoxy group, a sec-butylphenoxy group, a tert-butylphenoxy group, a n-hexylphenoxy group, a n-octylphenoxy group, a n-decylphenoxy group, a n-tetradecylphenoxy group, a naphthoxy group and an anthracenoxy group. Alternative examples thereof include aryloxy halide groups in which these aryloxy groups are substituted by a halogen atom such as a fluorine atom, a chlorine atom, a bromine atom or an iodine atom.

Examples of the substituted silyl group having 1 to 20 carbon atoms, represented by X¹, R¹, X², R³ or R⁴ can include silyl groups substituted by a hydrocarbyl group such as an alkyl group or an aryl group. Specific examples thereof include: monosubstituted silyl groups such as a methylsilyl group, an ethylsilyl group, a n-propylsilyl group, an isopropylsilyl group, a n-butylsilyl group, a sec-butylsilyl group, a tert-butylsilyl group, an isobutylsilyl group, a n-pentylsilyl group, a n-hexylsilyl group and a phenylsilyl group; disubstituted silyl groups such as a dimethylsilyl group, a diethylsilyl group, a di-n-propylsilyl group, a diisopropylsilyl group, a di-n-butylsilyl group, a di-sec-butylsilyl group, a di-tert-butylsilyl group, a diisobutylsilyl group and a diphenylsilyl group; and trisubstituted silyl groups such as a trimethylsilyl group, a triethylsilyl group, a tri-n-propylsilyl group, a triisopropylsilyl group, a tri-n-butylsilyl group, a tri-sec-butylsilyl group, a tri-tert-butylsilyl group, a triisobutylsilyl group, a tert-butyl-dimethylsilyl group, a tri-n-pentylsilyl group, a tri-n-hexylsilyl group, a tricyclohexylsilyl group and a triphenylsilyl group.

Examples of the substituted amino group having 1 to 20 carbon atoms, represented by X¹, R¹, X², R³ or R⁴ can include amino groups substituted by two hydrocarbyl groups such as an alkyl group or an aryl group. Specific examples thereof include a methylamino group, an ethylamino group, a n-propylamino group, an isopropylamino group, a n-butylamino group, a sec-butylamino group, a tert-butylamino group, an isobutylamino group, a n-hexylamino group, a n-octylamino group, a n-decylamino group, a phenylamino group, a benzylamino group, a dimethylamino group, a diethylamino group, a di-n-propylamino group, a diisopropylamino group, a di-n-butylamino group, a di-sec-butylamino group, a di-tert-butylamino group, a di-isobutylamino group, a tert-butylisopropylamino group, a di-n-hexylamino group, a di-n-octylamino group, a di-n-decylamino group, a diphenylamino group, a dibenzylamino group, a tert-butylisopropylamino group, a phenylethylamino group, a phenylpropylamino group, a phenylbutylamino group, a pyrrolyl group, a pyrrolidinyl group, a piperidinyl group, a carbazolyl group and a dihydroisoindolyl group.

X¹ is preferably a chlorine atom, a methyl group, an ethyl group, a n-propyl group, an isopropyl group, a n-butyl group, a methoxy group, an ethoxy group, a n-propoxy group, an isopropoxy group, a n-butoxy group, a trifluoromethoxy group, a phenyl group, a phenoxy group, a 2,6-di-tert-butylphenoxy group, a 3,4,5-trifluorophenoxy group, a pentafluorophenoxy group, a 2,3,5,6-tetrafluoro-4-pentafluorophenylphenoxy group or a benzyl group.

R¹ is preferably a hydrogen atom or an alkyl group having 1 to 6 carbon atoms, more preferably a hydrogen atom or an alkyl group having 1 to 4 carbon atoms, still more preferably a hydrogen atom.

X² is preferably a chlorine atom, a methyl group, an ethyl group, a n-propyl group, an isopropyl group, a n-butyl group, a methoxy group, an ethoxy group, a n-propoxy group, an isopropoxy group, a n-butoxy group, a trifluoromethoxy group, a phenyl group, a phenoxy group, a 2,6-di-tert-butylphenoxy group, a 3,4,5-trifluorophenoxy group, a pentafluorophenoxy group, a 2,3,5,6-tetrafluoro-4-pentafluorophenylphenoxy group or a benzyl group.

R³ is preferably a hydrogen atom or an alkyl group having 1 to 6 carbon atoms, more preferably a hydrogen atom or an alkyl group having 1 to 4 carbon atoms, still more preferably a hydrogen atom.

R⁴ is preferably a hydrogen atom or an alkyl group having 1 to 6 carbon atoms, more preferably a hydrogen atom or an alkyl group having 1 to 4 carbon atoms, still more preferably a hydrogen atom.

Q¹ in the general formula (1) represents a bridging group represented by the general formula (2). Q² in the general formula (3) represents a bridging group represented by the general formula (4).

m in the general formula (2) and n in the general formula (4) represent an integer of 1 to 5, respectively. m is preferably 1 or 2, and n is preferably 1 or 2.

J¹ in the general formula (2) and J² in the general formula (4) represent a transition metal atom in group 14 of the periodic table of elements, respectively. Examples thereof include a carbon atom, a silicon atom, and a germanium atom. The transition metal atom is preferably a carbon atom or a silicon atom.

R² in the general formula (2) and R⁵ in the general formula (4) each independently represent a hydrogen atom, a halogen atom, a hydrocarbyl group having 1 to 20 carbon atoms which may be substituted, a hydrocarbyloxy group having 1 to 20 carbon atoms which may be substituted, a substituted silyl group having 1 to 20 carbon atoms or a substituted amino group having 1 to 20 carbon atoms; the R² groups may be the same or different; and the R⁵ groups may be the same or different.

Examples of the halogen atom, the hydrocarbyl group having 1 to 20 carbon atoms which may be substituted, the hydrocarbyloxy group having 1 to 20 carbon atoms which may be substituted, the substituted silyl group having 1 to 20 carbon atoms and the substituted amino group having 1 to 20 carbon atoms, represented by R² or R⁵ can include those exemplified as the halogen atom, the hydrocarbyl group having 1 to 20 carbon atoms which may be substituted, the hydrocarbyloxy group having 1 to 20 carbon atoms which may be substituted, the substituted silyl group having 1 to 20 carbon atoms and the substituted amino group having 1 to 20 carbon atoms, represented by X¹, R¹, X², R³ or R⁴.

Examples of Q¹ and Q² can include a methylene group, an ethylidene group, an ethylene group, a propylidene group, a propylene group, a butylidene group, a butylene group, a pentylidene group, a pentylene group, a hexylidene group, an isopropylidene group, a methylethylmethylene group, a methylpropylmethylene group, a methylbutylmethylene group, a bis(cyclohexyl)methylene group, a methylphenylmethylene group, a diphenylmethylene group, a phenyl(methylphenyl)methylene group, a di(methylphenyl)methylene group, a bis(dimethylphenyl)methylene group, a bis(trimethylphenyl)methylene group, a phenyl(ethylphenyl)methylene group, a di(ethylphenyl)methylene group, a bis(diethylphenyl)methylene group, a phenyl(propylphenyl)methylene group, a di(propylphenyl)methylene group, a bis(dipropylphenyl)methylene group, a phenyl(butylphenyl)methylene group, a di(butylphenyl)methylene group, a phenyl(naphthyl)methylene group, a di(naphthyl)methylene group, a phenyl(biphenyl)methylene group, a di(biphenyl)methylene group, a phenyl(trimethylsilylphenyl)methylene group, a bis(trimethylsilylphenyl)methylene group, a bis(pentafluorophenyl)methylene group, a silanediyl group, a disilanediyl group, a trisilanediyl group, a tetrasilanediyl group, a dimethylsilanediyl group, a bis(dimethylsilane)diyl group, a diethylsilanediyl group, a dipropylsilanediyl group, a dibutylsilanediyl group, a diphenylsilanediyl group, a silacyclobutanediyl group, a silacyclohexanediyl group, a divinylsilanediyl group, a diallylsilanediyl group, a (methyl)(vinyl)silanediyl group and an (allyl)(methyl)silanediyl group.

Q¹ is preferably a methylene group, an ethylene group, an isopropylidene group, a bis(cyclohexyl)methylene group, a diphenylmethylene group, a dimethylsilanediyl group or a bis(dimethylsilane)diyl group, more preferably an ethylene group or a dimethylsilanediyl group. Moreover, Q² is preferably a methylene group, an ethylene group, an isopropylidene group, a bis(cyclohexyl)methylene group, a diphenylmethylene group, a dimethylsilanediyl group or a bis(dimethylsilane)diyl group, more preferably a diphenylmethylene group.

Examples of the transition metal compound (A1) represented by the general formula (1) can include transition metal compounds represented by the general formula (1) wherein M¹ represents a zirconium atom and X¹ represents a chlorine atom, such as methylenebis(indenyl)zirconium dichloride, isopropylidenebis(indenyl)zirconium dichloride, (methyl)(phenyl)methylenebis(indenyl)zirconium dichloride, diphenylmethylenebis(indenyl)zirconium dichloride, ethylenebis(indenyl)zirconium dichloride, methylenebis(methylindenyl)zirconium dichloride, isopropylidenebis(methylindenyl)zirconium dichloride, (methyl)(phenyl)methylenebis(methylindenyl)zirconium dichloride, diphenylmethylenebis(methylindenyl)zirconium dichloride, ethylenebis(methylindenyl)zirconium dichloride, methylene(indenyl)(methylindenyl)zirconium dichloride, isopropylidene(indenyl)(methylindenyl)zirconium dichloride, (methyl)(phenyl)methylene(indenyl)(methylindenyl)zirconium dichloride, diphenylmethylene(indenyl)(methylindenyl)zirconium dichloride, ethylene(indenyl)(methylindenyl)zirconium dichloride, methylenebis(2,4-dimethylindenyl)zirconium dichloride, isopropylidenebis(2,4-dimethylindenyl)zirconium dichloride, (methyl)(phenyl)methylenebis(2,4-dimethylindenyl)zirconium dichloride, diphenylmethylenebis(2,4-dimethylindenyl)zirconium dichloride, ethylenebis(2,4-dimethylindenyl)zirconium dichloride, dimethylsilanediylbis(indenyl)zirconium dichloride, diethylsilanediylbis(indenyl)zirconium dichloride, di(n-propyl)silanediylbis(indenyl)zirconium dichloride, diisopropylsilanediylbis(indenyl)zirconium dichloride, dicyclohexylsilanediylbis(indenyl)zirconium dichloride, diphenylsilanediylbis(indenyl)zirconium dichloride, di(p-tolyl)silanediylbis(indenyl)zirconium dichloride, divinylsilanediylbis(indenyl)zirconium dichloride, diallylsilanediylbis(indenyl)zirconium dichloride, (methyl)(vinyl)silanediylbis(indenyl)zirconium dichloride, (allyl)(methyl)silanediylbis(indenyl)zirconium dichloride, (ethyl)(methyl)silanediylbis(indenyl)zirconium dichloride, (methyl)(n-propyl)silanediylbis(indenyl)zirconium dichloride, (methyl)(isopropyl)silanediylbis(indenyl)zirconium dichloride, (cyclohexyl)(methyl)bis(indenyl)zirconium dichloride, (methyl)(phenyl)silanediylbis(indenyl)zirconium dichloride, dimethylsilanediylbis(methylindenyl)zirconium dichloride, diethylsilanediylbis(methylindenyl)zirconium dichloride, di(n-propyl)silanediylbis(methylindenyl)zirconium dichloride, diisopropylsilanediylbis(methylindenyl)zirconium dichloride, dicyclohexylsilanediylbis(methylindenyl)zirconium dichloride, diphenylsilanediylbis(methylindenyl)zirconium dichloride, (ethyl)(methyl)silanediylbis(methylindenyl)zirconium dichloride, (methyl)(n-propyl)silanediylbis(methylindenyl)zirconium dichloride, (methyl)(isopropyl)silanediylbis(methylindenyl)zirconium dichloride, (cyclohexyl)(methyl)bis(methylindenyl)zirconium dichloride, (methyl)(phenyl)silanediylbis(methylindenyl)zirconium dichloride, dimethylsilanediyl(indenyl)(methylindenyl)zirconium dichloride, diethylsilanediyl(indenyl)(methylindenyl)zirconium dichloride, di(n-propyl)silanediyl(indenyl)(methylindenyl)zirconium dichloride, diisopropylsilanediyl(indenyl)(methylindenyl)zirconium dichloride, dicyclohexylsilanediyl(indenyl)(methylindenyl)zirconium dichloride, diphenylsilanediykindenyl)(methylindenyl)zirconium dichloride, (ethyl)(methyl)silanediyl(indenyl)(methylindenyl)zirconium dichloride, (methyl)(n-propyl)silanediyl(indenyl)(methylindenyl)zirconium dichloride, (methyl)(isopropyl)silanediyl(indenyl)(methylindenyl)zirconium dichloride, (cyclohexyl)(methyl)(indenyl)(methylindenyl)zirconium dichloride, (methyl)(phenyl)silanediyl(indenyl)(methylindenyl)zirconium dichloride, dimethylsilanediylbis(2,4-dimethylindenyl)zirconium dichloride, diethylsilanediylbis(2,4-dimethylindenyl)zirconium dichloride, di(n-propyl)silanediylbis(2,4-dimethylindenyl)zirconium dichloride, diisopropylsilanediylbis(2,4-dimethylindenyl)zirconium dichloride, dicyclohexylsilanediylbis(2,4-dimethylindenyl)zirconium dichloride, diphenylsilanediylbis(2,4-dimethylindenyl)zirconium dichloride, (ethyl)(methyl)silanediylbis(2,4-dimethylindenyl)zirconium dichloride, (methyl)(n-propyl)silanediylbis(2,4-dimethylindenyl)zirconium dichloride, (methyl)(isopropyl)silanediylbis(2,4-dimethylindenyl)zirconium dichloride, (cyclohexyl)(methyl)bis(2,4-dimethylindenyl)zirconium dichloride and (methyl)(phenyl)silanediylbis(2,4-dimethylindenyl)zirconium dichloride.

In these examples, substituted forms of the η⁵-indenyl group include monosubstituted forms such as those substituted at 2-position, 3-position, 4-position, 5-position, 6-position or 7-position, when the bridging group is located at 1-position. Likewise, the monosubstituted forms also include all combinations even when the bridging site is a position other than 1-position. Likewise, di- or more substituted forms thereof also include all combinations of substituents and bridging sites. Alternative examples of the transition metal compound (A1) can include compounds in which dichloride as X¹ in the transition metal compounds exemplified above is changed to difluoride, dibromide, diiodide, dimethyl, diethyl, diisopropyl, dimethoxide, diethoxide, dipropoxide, dibutoxide, bis(trifluoromethoxide), diphenyl, diphenoxide, bis(2,6-di-tert-butylphenoxide), bis(3,4,5-trifluorophenoxide), bis(pentafluorophenoxide), bis(2,3,5,6-tetrafluoro-4-pentafluorophenylphenoxide), dibenzyl, or the like. Further examples thereof can include compounds in which zirconium as M¹ in the transition metal compounds exemplified above is changed to titanium or hafnium.

The transition metal compound (A1) represented by the general formula (1) is preferably ethylenebis(indenyl)zirconium diphenoxide, ethylenebis(indenyl)zirconium dichloride, or dimethylsilylenebis(indenyl)zirconium dichloride.

Examples of the transition metal compound (A2) represented by the general formula (3) can include transition metal compounds represented by the general formula (3) wherein M² represents a zirconium atom, X² represents a chlorine atom and the bridging group Q² represents a diphenylmethylene group, such as diphenylmethylene(1-cyclopentadienyl)(9-fluorenyl)zirconium dichloride, diphenylmethylene(2-methyl-1-cyclopentadienyl)(9-fluorenyl)zirconium dichloride, diphenylmethylene(3-methyl-1-cyclopentadienyl)(9-fluorenyl)zirconium dichloride, diphenylmethylene(2,4-dimethyl-1-cyclopentadienyl)(9-fluorenyl)zirconium dichloride, diphenylmethylene(2,5-dimethyl-1-cyclopentadienyl)(9-fluorenyl)zirconium dichloride, diphenylmethylene(3,4-dimethyl-1-cyclopentadienyl)(9-fluorenyl)zirconium dichloride, diphenylmethylene(2,3,4-trimethyl-1-cyclopentadienyl)(9-fluorenyl)zirconium dichloride, diphenylmethylene(2,3,5-trimethyl-1-cyclopentadienyl)(9-fluorenyl)zirconium dichloride, diphenylmethylene(3,4,5-trimethyl-1-cyclopentadienyl)(9-fluorenyl)zirconium dichloride, diphenylmethylene(2,3,4,5-tetramethyl-1-cyclopentadienyl)(9-fluorenyl)zirconium dichloride, diphenylmethylene(2-ethyl-1-cyclopentadienyl)(9-fluorenyl)zirconium dichloride, diphenylmethylene(3-ethyl-1-cyclopentadienyl)(9-fluorenyl)zirconium dichloride, diphenylmethylene(2,4-diethyl-1-cyclopentadienyl)(9-fluorenyl)zirconium dichloride, diphenylmethylene(2,5-diethyl-1-cyclopentadienyl)(9-fluorenyl)zirconium dichloride, diphenylmethylene(3,4-diethyl-1-cyclopentadienyl)(9-fluorenyl)zirconium dichloride, diphenylmethylene(2,3,4-triethyl-1-cyclopentadienyl)(9-fluorenyl)zirconium dichloride, diphenylmethylene(2,3,5-triethyl-1-cyclopentadienyl)(9-fluorenyl)zirconium dichloride, diphenylmethylene(3,4,5-triethyl-1-cyclopentadienyl)(9-fluorenyl)zirconium dichloride, diphenylmethylene(2,3,4,5-tetraethyl-1-cyclopentadienyl)(9-fluorenyl)zirconium dichloride, diphenylmethylene(2-n-propyl-1-cyclopentadienyl)(9-fluorenyl)zirconium dichloride, diphenylmethylene(3-n-propyl-1-cyclopentadienyl)(9-fluorenyl)zirconium dichloride, diphenylmethylene(2,4-di-n-propyl-1-cyclopentadienyl)(9-fluorenyl)zirconium dichloride, diphenylmethylene(2,5-di-n-propyl-1-cyclopentadienyl)(9-fluorenyl)zirconium dichloride, diphenylmethylene(3,4-di-n-propyl-1-cyclopentadienyl)(9-fluorenyl)zirconium dichloride, diphenylmethylene(2,3,4-tri-n-propyl-1-cyclopentadienyl)(9-fluorenyl)zirconium dichloride, diphenylmethylene(2,3,5-tri-n-propyl-1-cyclopentadienyl)(9-fluorenyl)zirconium dichloride, diphenylmethylene(3,4,5-tri-n-propyl-1-cyclopentadienyl)(9-fluorenyl)zirconium dichloride, diphenylmethylene(2,3,4,5-tetra-n-propyl-1-cyclopentadienyl)(9-fluorenyl)zirconium dichloride, diphenylmethylene(2-isopropyl-1-cyclopentadienyl)(9-fluorenyl)zirconium dichloride, diphenylmethylene(3-isopropyl-1-cyclopentadienyl)(9-fluorenyl)zirconium dichloride, diphenylmethylene(2,4-diisopropyl-1-cyclopentadienyl)(9-fluorenyl)zirconium dichloride, diphenylmethylene(2,5-diisopropyl-1-cyclopentadienyl)(9-fluorenyl)zirconium dichloride, diphenylmethylene(3,4-diisopropyl-1-cyclopentadienyl)(9-fluorenyl)zirconium dichloride, diphenylmethylene(2,3,4-triisopropyl-1-cyclopentadienyl)(9-fluorenyl)zirconium dichloride, diphenylmethylene(2,3,5-triisopropyl-1-cyclopentadienyl)(9-fluorenyl)zirconium dichloride, diphenylmethylene(3,4,5-triisopropyl-1-cyclopentadienyl)(9-fluorenyl)zirconium dichloride, diphenylmethylene(2,3,4,5-tetraisopropyl-1-cyclopentadienyl)(9-fluorenyl)zirconium dichloride, diphenylmethylene(2-phenyl-1-cyclopentadienyl)(9-fluorenyl)zirconium dichloride, diphenylmethylene(3-phenyl-1-cyclopentadienyl)(9-fluorenyl)zirconium dichloride, diphenylmethylene(2,4-diphenyl-1-cyclopentadienyl)(9-fluorenyl)zirconium dichloride, diphenylmethylene(2,5-diphenyl-1-cyclopentadienyl)(9-fluorenyl)zirconium dichloride, diphenylmethylene(3,4-diphenyl-1-cyclopentadienyl)(9-fluorenyl)zirconium dichloride, diphenylmethylene(2,3,4-triphenyl-1-cyclopentadienyl)(9-fluorenyl)zirconium dichloride, diphenylmethylene(2,3,5-triphenyl-1-cyclopentadienyl)(9-fluorenyl)zirconium dichloride, diphenylmethylene(3,4,5-triphenyl-1-cyclopentadienyl)(9-fluorenyl)zirconium dichloride, diphenylmethylene(2,3,4,5-tetraphenyl-1-cyclopentadienyl)(9-fluorenyl)zirconium dichloride, diphenylmethylene(2-trimethylsilyl-1-cyclopentadienyl)(9-fluorenyl)zirconium dichloride, diphenylmethylene(3-trimethylsilyl-1-cyclopentadienyl)(9-fluorenyl)zirconium dichloride, diphenylmethylene(2,4-bis(trimethylsilyl)-1-cyclopentadienyl)(9-fluorenyl)zirconium dichloride, diphenylmethylene(2,5-bis(trimethylsilyl)-1-cyclopentadienyl)(9-fluorenyl)zirconium dichloride, diphenylmethylene(3,4-bis(trimethylsilyl)-1-cyclopentadienyl)(9-fluorenyl)zirconium dichloride, diphenylmethylene(2,3,4-tris(trimethylsilyl)-1-cyclopentadienyl)(9-fluorenyl)zirconium dichloride, diphenylmethylene(2,3,5-tris(trimethylsilyl)-1-cyclopentadienyl)(9-fluorenyl)zirconium dichloride, diphenylmethylene(3,4,5-tris(trimethylsilyl)-1-cyclopentadienyl)(9-fluorenyl)zirconium dichloride, diphenylmethylene(2,3,4,5-tetrakis(trimethylsilyl)-1-cyclopentadienyl)(9-fluorenyl)zirconium dichloride, diphenylmethylene(1-cyclopentadienyl)(2,7-dimethyl-9-fluorenyl)zirconium dichloride, diphenylmethylene(2-methyl-1-cyclopentadienyl)(2,7-dimethyl-9-fluorenyl)zirconium dichloride, diphenylmethylene(3-methyl-1-cyclopentadienyl)(2,7-dimethyl-9-fluorenyl)zirconium dichloride, diphenylmethylene(2,4-dimethyl-1-cyclopentadienyl)(2,7-dimethyl-9-fluorenyl)zirconium dichloride, diphenylmethylene(2,5-dimethyl-1-cyclopentadienyl)(2,7-dimethyl-9-fluorenyl)zirconium dichloride, diphenylmethylene(3,4-dimethyl-1-cyclopentadienyl)(2,7-dimethyl-9-fluorenyl)zirconium dichloride, diphenylmethylene(2,3,4-trimethyl-1-cyclopentadienyl)(2,7-dimethyl-9-fluorenyl)zirconium dichloride, diphenylmethylene(2,3,5-trimethyl-1-cyclopentadienyl)(2,7-dimethyl-9-fluorenyl)zirconium dichloride, diphenylmethylene(3,4,5-trimethyl-1-cyclopentadienyl)(2,7-dimethyl-9-fluorenyl)zirconium dichloride, diphenylmethylene(2,3,4,5-tetramethyl-1-cyclopentadienyl)(2,7-dimethyl-9-fluorenyl)zirconium dichloride, diphenylmethylene(2-ethyl-1-cyclopentadienyl)(2,7-dimethyl-9-fluorenyl)zirconium dichloride, diphenylmethylene(3-ethyl-1-cyclopentadienyl)(2,7-dimethyl-9-fluorenyl)zirconium dichloride, diphenylmethylene(2,4-diethyl-1-cyclopentadienyl)(2,7-dimethyl-9-fluorenyl)zirconium dichloride, diphenylmethylene(2,5-diethyl-1-cyclopentadienyl)(2,7-dimethyl-9-fluorenyl)zirconium dichloride, diphenylmethylene(3,4-diethyl-1-cyclopentadienyl)(2,7-dimethyl-9-fluorenyl)zirconium dichloride, diphenylmethylene(2,3,4-triethyl-1-cyclopentadienyl)(2,7-dimethyl-9-fluorenyl)zirconium dichloride, diphenylmethylene(2,3,5-triethyl-1-cyclopentadienyl)(2,7-dimethyl-9-fluorenyl)zirconium dichloride, diphenylmethylene(3,4,5-triethyl-1-cyclopentadienyl)(2,7-dimethyl-9-fluorenyl)zirconium dichloride, diphenylmethylene(2,3,4,5-tetraethyl-1-cyclopentadienyl)(2,7-dimethyl-9-fluorenyl)zirconium dichloride, diphenylmethylene(2-n-propyl-1-cyclopentadienyl)(2,7-dimethyl-9-fluorenyl)zirconium dichloride, diphenylmethylene(3-n-propyl-1-cyclopentadienyl)(2,7-dimethyl-9-fluorenyl)zirconium dichloride, diphenylmethylene(2,4-di-n-propyl-1-cyclopentadienyl)(2,7-dimethyl-9-fluorenyl)zirconium dichloride, diphenylmethylene(2,5-di-n-propyl-1-cyclopentadienyl)(2,7-dimethyl-9-fluorenyl)zirconium dichloride, diphenylmethylene(3,4-di-n-propyl-1-cyclopentadienyl)(2,7-dimethyl-9-fluorenyl)zirconium dichloride, diphenylmethylene(2,3,4-tri-n-propyl-1-cyclopentadienyl)(2,7-dimethyl-9-fluorenyl)zirconium dichloride, diphenylmethylene(2,3,5-tri-n-propyl-1-cyclopentadienyl)(2,7-dimethyl-9-fluorenyl)zirconium dichloride, diphenylmethylene(3,4,5-tri-n-propyl-1-cyclopentadienyl)(2,7-dimethyl-9-fluorenyl)zirconium dichloride, diphenylmethylene(2,3,4,5-tetra-n-propyl-1-cyclopentadienyl)(2,7-dimethyl-9-fluorenyl)zirconium dichloride, diphenylmethylene(2-isopropyl-1-cyclopentadienyl)(2,7-dimethyl-9-fluorenyl)zirconium dichloride, diphenylmethylene(3-isopropyl-1-cyclopentadienyl)(2,7-dimethyl-9-fluorenyl)zirconium dichloride, diphenylmethylene(2,4-diisopropyl-1-cyclopentadienyl)(2,7-dimethyl-9-fluorenyl)zirconium dichloride, diphenylmethylene(2,5-diisopropyl-1-cyclopentadienyl)(2,7-dimethyl-9-fluorenyl)zirconium dichloride, diphenylmethylene(3,4-diisopropyl-1-cyclopentadienyl)(2,7-dimethyl-9-fluorenyl)zirconium dichloride, diphenylmethylene(2,3,4-triisopropyl-1-cyclopentadienyl)(2,7-dimethyl-9-fluorenyl)zirconium dichloride, diphenylmethylene(2,3,5-triisopropyl-1-cyclopentadienyl)(2,7-dimethyl-9-fluorenyl)zirconium dichloride, diphenylmethylene(3,4,5-triisopropyl-1-cyclopentadienyl)(2,7-dimethyl-9-fluorenyl)zirconium dichloride, diphenylmethylene(2,3,4,5-tetraisopropyl-1-cyclopentadienyl)(2,7-dimethyl-9-fluorenyl)zirconium dichloride, diphenylmethylene(2-phenyl-1-cyclopentadienyl)(2,7-dimethyl-9-fluorenyl)zirconium dichloride, diphenylmethylene(3-phenyl-1-cyclopentadienyl)(2,7-dimethyl-9-fluorenyl)zirconium dichloride, diphenylmethylene(2,4-diphenyl-1-cyclopentadienyl)(2,7-dimethyl-9-fluorenyl)zirconium dichloride, diphenylmethylene(2,5-diphenyl-1-cyclopentadienyl)(2,7-dimethyl-9-fluorenyl)zirconium dichloride, diphenylmethylene(3,4-diphenyl-1-cyclopentadienyl)(2,7-dimethyl-9-fluorenyl)zirconium dichloride, diphenylmethylene(2,3,4-triphenyl-1-cyclopentadienyl)(2,7-dimethyl-9-fluorenyl)zirconium dichloride, diphenylmethylene(2,3,5-triphenyl-1-cyclopentadienyl)(2,7-dimethyl-9-fluorenyl)zirconium dichloride, diphenylmethylene(3,4,5-triphenyl-1-cyclopentadienyl)(2,7-dimethyl-9-fluorenyl)zirconium dichloride, diphenylmethylene(2,3,4,5-tetraphenyl-1-cyclopentadienyl)(2,7-dimethyl-9-fluorenyl)zirconium dichloride, diphenylmethylene(2-trimethylsilyl-1-cyclopentadienyl)(2,7-dimethyl-9-fluorenyl)zirconium dichloride, diphenylmethylene(3-trimethylsilyl-1-cyclopentadienyl)(2,7-dimethyl-9-fluorenyl)zirconium dichloride, diphenylmethylene(2,4-bis(trimethylsilyl)-1-cyclopentadienyl)(2,7-dimethyl-9-fluorenyl)zirconium dichloride, diphenylmethylene(2,5-bis(trimethylsilyl)-1-cyclopentadienyl)(2,7-dimethyl-9-fluorenyl)zirconium dichloride, diphenylmethylene(3,4-bis(trimethylsilyl)-1-cyclopentadienyl)(2,7-dimethyl-9-fluorenyl)zirconium dichloride, diphenylmethylene(2,3,4-tris(trimethylsilyl)-1-cyclopentadienyl)(2,7-dimethyl-9-fluorenyl)zirconium dichloride, diphenylmethylene(2,3,5-tris(trimethylsilyl)-1-cyclopentadienyl)(2,7-dimethyl-9-fluorenyl)zirconium dichloride, diphenylmethylene(3,4,5-tris(trimethylsilyl)-1-cyclopentadienyl)(2,7-dimethyl-9-fluorenyl)zirconium dichloride, diphenylmethylene(2,3,4,5-tetrakis(trimethylsilyl)-1-cyclopentadienyl)(2,7-dimethyl-9-fluorenyl)zirconium dichloride, diphenylmethylene(1-cyclopentadienyl)(2,7-diethyl-9-fluorenyl)zirconium dichloride, diphenylmethylene(2-methyl-1-cyclopentadienyl)(2,7-diethyl-9-fluorenyl)zirconium dichloride, diphenylmethylene(3-methyl-1-cyclopentadienyl)(2,7-diethyl-9-fluorenyl)zirconium dichloride, diphenylmethylene(2,4-dimethyl-1-cyclopentadienyl)(2,7-diethyl-9-fluorenyl)zirconium dichloride, diphenylmethylene(2,5-dimethyl-1-cyclopentadienyl)(2,7-diethyl-9-fluorenyl)zirconium dichloride, diphenylmethylene(3,4-dimethyl-1-cyclopentadienyl)(2,7-diethyl-9-fluorenyl)zirconium dichloride, diphenylmethylene(2,3,4-trimethyl-1-cyclopentadienyl)(2,7-diethyl-9-fluorenyl)zirconium dichloride, diphenylmethylene(2,3,5-trimethyl-1-cyclopentadienyl)(2,7-diethyl-9-fluorenyl)zirconium dichloride, diphenylmethylene(3,4,5-trimethyl-1-cyclopentadienyl)(2,7-diethyl-9-fluorenyl)zirconium dichloride, diphenylmethylene(2,3,4,5-tetramethyl-1-cyclopentadienyl)(2,7-diethyl-9-fluorenyl)zirconium dichloride, diphenylmethylene(2-ethyl-1-cyclopentadienyl)(2,7-diethyl-9-fluorenyl)zirconium dichloride, diphenylmethylene(3-ethyl-1-cyclopentadienyl)(2,7-diethyl-9-fluorenyl)zirconium dichloride, diphenylmethylene(2,4-diethyl-1-cyclopentadienyl)(2,7-diethyl-9-fluorenyl)zirconium dichloride, diphenylmethylene(2,5-diethyl-1-cyclopentadienyl)(2,7-diethyl-9-fluorenyl)zirconium dichloride, diphenylmethylene(3,4-diethyl-1-cyclopentadienyl)(2,7-diethyl-9-fluorenyl)zirconium dichloride, diphenylmethylene(2,3,4-triethyl-1-cyclopentadienyl)(2,7-diethyl-9-fluorenyl)zirconium dichloride, diphenylmethylene(2,3,5-triethyl-1-cyclopentadienyl)(2,7-diethyl-9-fluorenyl)zirconium dichloride, diphenylmethylene(3,4,5-triethyl-1-cyclopentadienyl)(2,7-diethyl-9-fluorenyl)zirconium dichloride, diphenylmethylene(2,3,4,5-tetraethyl-1-cyclopentadienyl)(2,7-diethyl-9-fluorenyl)zirconium dichloride, diphenylmethylene(2-n-propyl-1-cyclopentadienyl)(2,7-diethyl-9-fluorenyl)zirconium dichloride, diphenylmethylene(3-n-propyl-1-cyclopentadienyl)(2,7-diethyl-9-fluorenyl)zirconium dichloride, diphenylmethylene(2,4-di-n-propyl-1-cyclopentadienyl)(2,7-diethyl-9-fluorenyl)zirconium dichloride, diphenylmethylene(2,5-di-n-propyl-1-cyclopentadienyl)(2,7-diethyl-9-fluorenyl)zirconium dichloride, diphenylmethylene(3,4-di-n-propyl-1-cyclopentadienyl)(2,7-diethyl-9-fluorenyl)zirconium dichloride, diphenylmethylene(2,3,4-tri-n-propyl-1-cyclopentadienyl)(2,7-diethyl-9-fluorenyl)zirconium dichloride, diphenylmethylene(2,3,5-tri-n-propyl-1-cyclopentadienyl)(2,7-diethyl-9-fluorenyl)zirconium dichloride, diphenylmethylene(3,4,5-tri-n-propyl-1-cyclopentadienyl)(2,7-diethyl-9-fluorenyl)zirconium dichloride, diphenylmethylene(2,3,4,5-tetra-n-propyl-1-cyclopentadienyl)(2,7-diethyl-9-fluorenyl)zirconium dichloride, diphenylmethylene(2-isopropyl-1-cyclopentadienyl)(2,7-diethyl-9-fluorenyl)zirconium dichloride, diphenylmethylene(3-isopropyl-1-cyclopentadienyl)(2,7-diethyl-9-fluorenyl)zirconium dichloride, diphenylmethylene(2,4-diisopropyl-1-cyclopentadienyl)(2,7-diethyl-9-fluorenyl)zirconium dichloride, diphenylmethylene(2,5-diisopropyl-1-cyclopentadienyl)(2,7-diethyl-9-fluorenyl)zirconium dichloride, diphenylmethylene(3,4-diisopropyl-1-cyclopentadienyl)(2,7-diethyl-9-fluorenyl)zirconium dichloride, diphenylmethylene(2,3,4-triisopropyl-1-cyclopentadienyl)(2,7-diethyl-9-fluorenyl)zirconium dichloride, diphenylmethylene(2,3,5-triisopropyl-1-cyclopentadienyl)(2,7-diethyl-9-fluorenyl)zirconium dichloride, diphenylmethylene(3,4,5-triisopropyl-1-cyclopentadienyl)(2,7-diethyl-9-fluorenyl)zirconium dichloride, diphenylmethylene(2,3,4,5-tetraisopropyl-1-cyclopentadienyl)(2,7-diethyl-9-fluorenyl)zirconium dichloride, diphenylmethylene(2-phenyl-1-cyclopentadienyl)(2,7-diethyl-9-fluorenyl)zirconium dichloride, diphenylmethylene(3-phenyl-1-cyclopentadienyl)(2,7-diethyl-9-fluorenyl)zirconium dichloride, diphenylmethylene(2,4-diphenyl-1-cyclopentadienyl)(2,7-diethyl-9-fluorenyl)zirconium dichloride, diphenylmethylene(2,5-diphenyl-1-cyclopentadienyl)(2,7-diethyl-9-fluorenyl)zirconium dichloride, diphenylmethylene(3,4-diphenyl-1-cyclopentadienyl)(2,7-diethyl-9-fluorenyl)zirconium dichloride, diphenylmethylene(2,3,4-triphenyl-1-cyclopentadienyl)(2,7-diethyl-9-fluorenyl)zirconium dichloride, diphenylmethylene(2,3,5-triphenyl-1-cyclopentadienyl)(2,7-diethyl-9-fluorenyl)zirconium dichloride, diphenylmethylene(3,4,5-triphenyl-1-cyclopentadienyl)(2,7-diethyl-9-fluorenyl)zirconium dichloride, diphenylmethylene(2,3,4,5-tetraphenyl-1-cyclopentadienyl)(2,7-diethyl-9-fluorenyl)zirconium dichloride, diphenylmethylene(2-trimethylsilyl-1-cyclopentadienyl)(2,7-diethyl-9-fluorenyl)zirconium dichloride, diphenylmethylene(3-trimethylsilyl-1-cyclopentadienyl)(2,7-diethyl-9-fluorenyl)zirconium dichloride, diphenylmethylene(2,4-bis(trimethylsilyl)-1-cyclopentadienyl)(2,7-diethyl-9-fluorenyl)zirconium dichloride, diphenylmethylene(2,5-bis(trimethylsilyl)-1-cyclopentadienyl)(2,7-diethyl-9-fluorenyl)zirconium dichloride, diphenylmethylene(3,4-bis(trimethylsilyl)-1-cyclopentadienyl)(2,7-diethyl-9-fluorenyl)zirconium dichloride, diphenylmethylene(2,3,4-tris(trimethylsilyl)-1-cyclopentadienyl)(2,7-diethyl-9-fluorenyl)zirconium dichloride, diphenylmethylene(2,3,5-tris(trimethylsilyl)-1-cyclopentadienyl)(2,7-diethyl-9-fluorenyl)zirconium dichloride, diphenylmethylene(3,4,5-tris(trimethylsilyl)-1-cyclopentadienyl)(2,7-diethyl-9-fluorenyl)zirconium dichloride, diphenylmethylene(2,3,4,5-tetrakis(trimethylsilyl)-1-cyclopentadienyl)(2,7-diethyl-9-fluorenyl)zirconium dichloride, diphenylmethylene(1-cyclopentadienyl)(2,7-di-t-butyl-9-fluorenyl)zirconium dichloride, diphenylmethylene(2-methyl-1-cyclopentadienyl)(2,7-di-t-butyl-9-fluorenyl)zirconium dichloride, diphenylmethylene(3-methyl-1-cyclopentadienyl)(2,7-di-t-butyl-9-fluorenyl)zirconium dichloride, diphenylmethylene(2,4-dimethyl-1-cyclopentadienyl)(2,7-di-t-butyl-9-fluorenyl)zirconium dichloride, diphenylmethylene(2,5-dimethyl-1-cyclopentadienyl)(2,7-di-t-butyl-9-fluorenyl)zirconium dichloride, diphenylmethylene(3,4-dimethyl-1-cyclopentadienyl)(2,7-di-t-butyl-9-fluorenyl)zirconium dichloride, diphenylmethylene(2,3,4-trimethyl-1-cyclopentadienyl)(2,7-di-t-butyl-9-fluorenyl)zirconium dichloride, diphenylmethylene(2,3,5-trimethyl-1-cyclopentadienyl)(2,7-di-t-butyl-9-fluorenyl)zirconium dichloride, diphenylmethylene(3,4,5-trimethyl-1-cyclopentadienyl)(2,7-di-t-butyl-9-fluorenyl)zirconium dichloride, diphenylmethylene(2,3,4,5-tetramethyl-1-cyclopentadienyl)(2,7-di-t-butyl-9-fluorenyl)zirconium dichloride, diphenylmethylene(2-ethyl-1-cyclopentadienyl)(2,7-di-t-butyl-9-fluorenyl)zirconium dichloride, diphenylmethylene(3-ethyl-1-cyclopentadienyl)(2,7-di-t-butyl-9-fluorenyl)zirconium dichloride, diphenylmethylene(2,4-diethyl-1-cyclopentadienyl)(2,7-di-t-butyl-9-fluorenyl)zirconium dichloride, diphenylmethylene(2,5-diethyl-1-cyclopentadienyl)(2,7-di-t-butyl-9-fluorenyl)zirconium dichloride, diphenylmethylene(3,4-diethyl-1-cyclopentadienyl)(2,7-di-t-butyl-9-fluorenyl)zirconium dichloride, diphenylmethylene(2,3,4-triethyl-1-cyclopentadienyl)(2,7-di-t-butyl-9-fluorenyl)zirconium dichloride, diphenylmethylene(2,3,5-triethyl-1-cyclopentadienyl)(2,7-di-t-butyl-9-fluorenyl)zirconium dichloride, diphenylmethylene(3,4,5-triethyl-1-cyclopentadienyl)(2,7-di-t-butyl-9-fluorenyl)zirconium dichloride, diphenylmethylene(2,3,4,5-tetraethyl-1-cyclopentadienyl)(2,7-di-t-butyl-9-fluorenyl)zirconium dichloride, diphenylmethylene(2-n-propyl-1-cyclopentadienyl)(2,7-di-t-butyl-9-fluorenyl)zirconium dichloride, diphenylmethylene(3-n-propyl-1-cyclopentadienyl)(2,7-di-t-butyl-9-fluorenyl)zirconium dichloride, diphenylmethylene(2,4-di-n-propyl-1-cyclopentadienyl)(2,7-di-t-butyl-9-fluorenyl)zirconium dichloride, diphenylmethylene(2,5-di-n-propyl-1-cyclopentadienyl)(2,7-di-t-butyl-9-fluorenyl)zirconium dichloride, diphenylmethylene(3,4-di-n-propyl-1-cyclopentadienyl)(2,7-di-t-butyl-9-fluorenyl)zirconium dichloride, diphenylmethylene(2,3,4-tri-n-propyl-1-cyclopentadienyl)(2,7-di-t-butyl-9-fluorenyl)zirconium dichloride, diphenylmethylene(2,3,5-tri-n-propyl-1-cyclopentadienyl)(2,7-di-t-butyl-9-fluorenyl)zirconium dichloride, diphenylmethylene(3,4,5-tri-n-propyl-1-cyclopentadienyl)(2,7-di-t-butyl-9-fluorenyl)zirconium dichloride, diphenylmethylene(2,3,4,5-tetra-n-propyl-1-cyclopentadienyl)(2,7-di-t-butyl-9-fluorenyl)zirconium dichloride, diphenylmethylene(2-isopropyl-1-cyclopentadienyl)(2,7-di-t-butyl-9-fluorenyl)zirconium dichloride, diphenylmethylene(3-isopropyl-1-cyclopentadienyl)(2,7-di-t-butyl-9-fluorenyl)zirconium dichloride, diphenylmethylene(2,4-diisopropyl-1-cyclopentadienyl)(2,7-di-t-butyl-9-fluorenyl)zirconium dichloride, diphenylmethylene(2,5-diisopropyl-1-cyclopentadienyl)(2,7-di-t-butyl-9-fluorenyl)zirconium dichloride, diphenylmethylene(3,4-diisopropyl-1-cyclopentadienyl)(2,7-di-t-butyl-9-fluorenyl)zirconium dichloride, diphenylmethylene(2,3,4-triisopropyl-1-cyclopentadienyl)(2,7-di-t-butyl-9-fluorenyl)zirconium dichloride, diphenylmethylene(2,3,5-triisopropyl-1-cyclopentadienyl)(2,7-di-t-butyl-9-fluorenyl)zirconium dichloride, diphenylmethylene(3,4,5-triisopropyl-1-cyclopentadienyl)(2,7-di-t-butyl-9-fluorenyl)zirconium dichloride, diphenylmethylene(2,3,4,5-tetraisopropyl-1-cyclopentadienyl)(2,7-di-t-butyl-9-fluorenyl)zirconium dichloride, diphenylmethylene(2-phenyl-1-cyclopentadienyl)(2,7-di-t-butyl-9-fluorenyl)zirconium dichloride, diphenylmethylene(3-phenyl-1-cyclopentadienyl)(2,7-di-t-butyl-9-fluorenyl)zirconium dichloride, diphenylmethylene(2,4-diphenyl-1-cyclopentadienyl)(2,7-di-t-butyl-9-fluorenyl)zirconium dichloride, diphenylmethylene(2,5-diphenyl-1-cyclopentadienyl)(2,7-di-t-butyl-9-fluorenyl)zirconium dichloride, diphenylmethylene(3,4-diphenyl-1-cyclopentadienyl)(2,7-di-t-butyl-9-fluorenyl)zirconium dichloride, diphenylmethylene(2,3,4-triphenyl-1-cyclopentadienyl)(2,7-di-t-butyl-9-fluorenyl)zirconium dichloride, diphenylmethylene(2,3,5-triphenyl-1-cyclopentadienyl)(2,7-di-t-butyl-9-fluorenyl)zirconium dichloride, diphenylmethylene(3,4,5-triphenyl-1-cyclopentadienyl)(2,7-di-t-butyl-9-fluorenyl)zirconium dichloride, diphenylmethylene(2,3,4,5-tetraphenyl-1-cyclopentadienyl)(2,7-di-t-butyl-9-fluorenyl)zirconium dichloride, diphenylmethylene(2-trimethylsilyl-1-cyclopentadienyl)(2,7-di-t-butyl-9-fluorenyl)zirconium dichloride, diphenylmethylene(3-trimethylsilyl-1-cyclopentadienyl)(2,7-di-t-butyl-9-fluorenyl)zirconium dichloride, diphenylmethylene(2,4-bis(trimethylsilyl)-1-cyclopentadienyl)(2,7-di-t-butyl-9-fluorenyl)zirconium dichloride, diphenylmethylene(2,5-bis(trimethylsilyl)-1-cyclopentadienyl)(2,7-di-t-butyl-9-fluorenyl)zirconium dichloride, diphenylmethylene(3,4-bis(trimethylsilyl)-1-cyclopentadienyl)(2,7-di-t-butyl-9-fluorenyl)zirconium dichloride, diphenylmethylene(2,3,4-tris(trimethylsilyl)-1-cyclopentadienyl)(2,7-di-t-butyl-9-fluorenyl)zirconium dichloride, diphenylmethylene(2,3,5-tris(trimethylsilyl)-1-cyclopentadienyl)(2,7-di-t-butyl-9-fluorenyl)zirconium dichloride, diphenylmethylene(3,4,5-tris(trimethylsilyl)-1-cyclopentadienyl)(2,7-di-t-butyl-9-fluorenyl)zirconium dichloride and diphenylmethylene(2,3,4,5-tetrakis(trimethylsilyl)-1-cyclopentadienyl)(2,7-di-t-butyl-9-fluorenyl)zirconium dichloride.

Alternative examples of the transition metal compound (A2) can include compounds in which dichloride as X² in the transition metal compounds exemplified above is changed to difluoride, dibromide, diiodide, dimethyl, diethyl, diisopropyl, dimethoxide, diethoxide, dipropoxide, dibutoxide, bis(trifluoromethoxide), diphenyl, diphenoxide, bis(2,6-di-tert-butylphenoxide), bis(3,4,5-trifluorophenoxide), bis(pentafluorophenoxide), bis(2,3,5,6-tetrafluoro-4-pentafluorophenylphenoxide), dibenzyl, or the like. Further examples thereof can include compounds in which the diphenylmethylene group as Q² in the transition metal compounds exemplified above is changed to a methylene group, an ethylene group, an isopropylidene group, a methylphenylmethylene group, a dimethylsilanediyl group, a diphenylsilanediyl group, a silacyclobutanediyl group, a silacyclohexanediyl group, or the like. Further examples thereof can also include compounds in which zirconium as M² in the transition metal compounds exemplified above is changed to titanium or hafnium.

The transition metal compound (A2) represented by the general formula (3) is preferably diphenylmethylene(1-cyclopentadienyl)(9-fluorenyl)zirconium dichloride.

Examples of the promoter component (B) used for preparing the polymerization catalyst used in the production of the ethylene-α-olefin copolymer of the present invention include a solid catalyst component obtained by bringing the following components (b1), (b2), (b3) and (b4) into contact with each other:

(b1): a compound represented by the following general formula (5):

M³Lₓ (5)

(b2): a compound represented by the following general formula (6):

Rₜ₋₁⁶TH (6)

(b3): a compound represented by the following general formula (7):

Rₜ₋₂⁷TH₂ (7)

(b4): a granular carrier

wherein M³ represents a metal atom in group 1, 2, 12, 14 or 15 of the periodic table of elements; x represents a number corresponding to the valence of M³; L represents a hydrogen atom, a halogen atom or a hydrocarbyl group which may be substituted; when there are more than one L, they may be the same or differen; T each independently represents a nonmetal atom in group 15 or 16 of the periodic table of elements; t represents a number corresponding to the valence of T in each compound; R⁶ represents a halogen atom, an electron-withdrawing group, a halogenated group or a group having an electron-withdrawing group; when there are more than one R⁶, they may be the same or different; and R⁷ represents a halogen atom, a hydrocarbyl group or a hydrocarbyl halide group.

M³ in the general formula (5) represents a metal atom in group 1, 2, 12, 14 or 15 of the periodic table of elements. Examples of M³ can include a lithium atom, a sodium atom, a potassium atom, a rubidium atom, a cesium atom, a beryllium atom, a magnesium atom, a calcium atom, a strontium atom, a barium atom, a zinc atom, a germanium atom, a tin atom, a lead atom, an antimony atom and a bismuth atom. M³ is preferably a magnesium atom, a calcium atom, a strontium atom, a barium atom, a zinc atom, a germanium atom, a tin atom or a bismuth atom, more preferably a magnesium atom, a zinc atom, a tin atom or a bismuth atom, still more preferably a zinc atom.

x in the general formula (5) represents a number corresponding to the valence of M³. For example, when M³ is a zinc atom, x is 2.

L in the general formula (5) represents a hydrogen atom, a halogen atom or a hydrocarbyl group which may be substituted. When there are more than one L, they may be the same or different.

Examples of the halogen atom represented by L include a fluorine atom, a chlorine atom, a bromine atom and an iodine atom.

Examples of the hydrocarbyl group which may be substituted, represented by L include an alkyl group, an aralkyl group, an aryl group and an alkyl halide group.

The alkyl group as L is preferably an alkyl group having 1 to 20 carbon atoms. Examples thereof include a methyl group, an ethyl group, a n-propyl group, an isopropyl group, a n-butyl group, a sec-butyl group, a tert-butyl group, a n-pentyl group, a neopentyl group, an isopentyl group, a n-hexyl group, a n-heptyl group, a n-octyl group, a n-decyl group, a n-nonyl group, a n-decyl group, a n-dodecyl group, a n-dodecyl group, a n-tridecyl group, a n-tetradecyl group, a n-pentadecyl group, a n-hexadecyl group, a n-heptadecyl group, a n-octadecyl group, a n-nonadecyl group and a n-eicosyl group. The alkyl group is preferably a methyl group, an ethyl group, an isopropyl group, a tert-butyl group or an isobutyl group.

The alkyl halide group as L is preferably an alkyl halide group having 1 to 20 carbon atoms. Examples thereof include a fluoromethyl group, a difluoromethyl group, a trifluoromethyl group, a chloromethyl group, a dichloromethyl group, a trichloromethyl group, a bromomethyl group, a dibromomethyl group, a tribromomethyl group, an iodomethyl group, a diiodomethyl group, a triiodomethyl group, a fluoroethyl group, a difluoroethyl group, a trifluoroethyl group, a tetrafluoroethyl group, a pentafluoroethyl group, a chloroethyl group, a dichloroethyl group, a trichloroethyl group, a tetrachloroethyl group, a pentachloroethyl group, a bromoethyl group, a dibromoethyl group, a tribromoethyl group, a tetrabromoethyl group, a pentabromoethyl group, a perfluoropropyl group, a perfluorobutyl group, a perfluoropentyl group, a perfluorohexyl group, a perfluorooctyl group, a perfluorododecyl group, a perfluoropentadecyl group, a perfluoroeicosyl group, a perchloropropyl group, a perchlorobutyl group, a perchloropentyl group, a perchlorohexyl group, a perchlorooctyl group, a perchlorododecyl group, a perchloropentadecyl group, a perchloroeicosyl group, a perbromopropyl group, a perbromobutyl group, a perbromopentyl group, a perbromohexyl group, a perbromooctyl group, a perbromododecyl group, a perbromopentadecyl group and a perbromoeicosyl group.

The aralkyl group as L is preferably an aralkyl group having 7 to 20 carbon atoms. Examples thereof include a benzyl group, a (2-methylphenyl)methyl group, a (3-methylphenyl)methyl group, a (4-methylphenyl)methyl group, a (2,3-dimethylphenyl)methyl group, a (2,4-dimethylphenyl)methyl group, a (2,5-dimethylphenyl)methyl group, a (2,6-dimethylphenyl)methyl group, a (3,4-dimethylphenyl)methyl group, a (4,6-dimethylphenyl)methyl group, a (2,3,4-trimethylphenyl)methyl group, a (2,3,5-trimethylphenyl)methyl group, a (2,3,6-trimethylphenyl)methyl group, a (3,4,5-trimethylphenyl)methyl group, a (2,4,6-trimethylphenyl)methyl group, a (2,3,4,5-tetramethylphenyl)methyl group, a (2,3,4,6-tetramethylphenyl)methyl group, a (2,3,5,6-tetramethylphenyl)methyl group, a (pentamethylphenyl)methyl group, an (ethylphenyl)methyl group, an (n-propylphenyl)methyl group, an (isopropylphenyl)methyl group, an (n-butylphenyl)methyl group, a (sec-butylphenyl)methyl group, a (tert-butylphenyl)methyl group, an (n-pentylphenyl)methyl group, a (neopentylphenyl)methyl group, an (n-hexylphenyl)methyl group, an (n-octylphenyl)methyl group, an (n-decylphenyl)methyl group, an (n-decylphenyl)methyl group, an (n-tetradecylphenyl)methyl group, a naphthylmethyl group, an anthracenylmethyl group, a phenylethyl group, a phenylpropyl group, a phenylbutyl group, a diphenylmethyl group, a diphenylethyl group, a diphenylpropyl group and a diphenylbutyl group. The aralkyl group is preferably a benzyl group. Alternative examples thereof include aralkyl halide groups having 7 to 20 carbon atoms in which these aralkyl groups are substituted by a halogen atom such as a fluorine atom, a chlorine atom, a bromine atom or an iodine atom.

The aryl group as L is preferably an aryl group having 6 to 20 carbon atoms. Examples thereof include a phenyl group, a 2-tolyl group, a 3-tolyl group, a 4-tolyl group, a 2,3-xylyl group, a 2,4-xylyl group, a 2,5-xylyl group, a 2,6-xylyl group, a 3,4-xylyl group, a 3,5-xylyl group, a 2,3,4-trimethylphenyl group, a 2,3,5-trimethylphenyl group, a 2,3,6-trimethylphenyl group, a 2,4,6-trimethylphenyl group, a 3,4,5-trimethylphenyl group, a 2,3,4,5-tetramethylphenyl group, a 2,3,4,6-tetramethylphenyl group, a 2,3,5,6-tetramethylphenyl group, a pentamethylphenyl group, an ethylphenyl group, a diethylphenyl group, a triethylphenyl group, a n-propylphenyl group, an isopropylphenyl group, a n-butylphenyl group, a sec-butylphenyl group, a tert-butylphenyl group, a n-pentylphenyl group, a neopentylphenyl group, a n-hexylphenyl group, a n-octylphenyl group, a n-decylphenyl group, a n-dodecylphenyl group, a n-tetradecylphenyl group, a naphthyl group and an anthracenyl group and preferably include a phenyl group. Alternative examples thereof include aryl halide groups having 6 to 20 carbon atoms in which these aryl groups are substituted by a halogen atom such as a fluorine atom, a chlorine atom, a bromine atom or an iodine atom.

L is preferably a hydrogen atom, an alkyl group or an aryl group, more preferably a hydrogen atom or an alkyl group, still more preferably an alkyl group.

T in the general formulas (6) and (7) represents a nonmetal atom in group 15 or 16 of the periodic table of elements. T in the general formula (6) and T in the general formula (7) may be the same as or different from each other. Specific examples of the nonmetal atom in group 15 include a nitrogen atom and a phosphorus atom. Specific examples of the nonmetal atom in group 16 include an oxygen atom and a sulfur atom.

T is preferably a nitrogen atom or an oxygen atom, more preferably an oxygen atom.

t in the general formulas (6) and (7) represents the valence of T in each formula. When T is a nonmetal atom in group 15, t is 3. When T is a nonmetal atom in group 16, t is 2.

R⁶ in the general formula (6) represents a halogen atom, an electron-withdrawing group, a halogenated group or a group having an electron-withdrawing group and represents a group containing an electron-withdrawing group or an electron-withdrawing group. When a plurality of R⁶ are present, they may be the same as or different from each other. For example, a substituent constant σ in Hammett's rule is known as an index for electron-withdrawing properties. Examples of the electron-withdrawing group include functional groups having a positive substituent constant σ in Hammett's rule.

Examples of the halogen atom represented by R⁶ include a fluorine atom, a chlorine atom, a bromine atom and an iodine atom.

Examples of the electron-withdrawing group represented by R⁶ include a cyano group, a nitro group, a carbonyl group, a hydrocarbyloxycarbonyl group, a sulfone group and a phenyl group.

Examples of the halogenated group represented by R⁶ include: hydrocarbyl halide groups such as an alkyl halide group, an aralkyl halide group, an aryl halide group and an (alkyl halide)aryl group; hydrocarbyloxy halide groups; and hydrocarbyloxycarbonyl halide groups. Moreover, examples of the group having an electron-withdrawing group, represented by R⁶ include: hydrocarbyl cyanide groups such as an aryl cyanide group; and hydrocarbyl nitride groups such as an aryl nitride group.

Examples of the alkyl halide group as R⁶ include a fluoromethyl group, a chloromethyl group, a bromomethyl group, an iodomethyl group, a difluoromethyl group, a dichloromethyl group, a dibromomethyl group, a diiodomethyl group a trifluoromethyl group, a trichloromethyl group, a tribromomethyl group, a triiodomethyl group, a 2,2,2-trifluoroethyl group, a 2,2,2-trichloroethyl group, a 2,2,2-tribromoethyl group, a 2,2,2-triiodoethyl group, a 2,2,3,3,3-pentafluoropropyl group, a 2,2,3,3,3-pentachloropropyl group, a 2,2,3,3,3-pentabromopropyl group, a 2,2,3,3,3-pentaiodopropyl group, a 2,2,2-trifluoro-1-trifluoromethylethyl group, a 2,2,2-trichloro-1-trichloromethylethyl group, a 2,2,2-tribromo-1-tribromomethylethyl group, a 2,2,2-triiodo-1-triiodomethylethyl group, a 1,1-bis(trifluoromethyl)-2,2,2-trifluoroethyl group, a 1,1-bis(trichloromethyl)-2,2,2-trichloroethyl group, a 1,1-bis(tribromomethyl)-2,2,2-tribromoethyl group and a 1,1-bis(triiodomethyl)-2,2,2-triiodoethyl group.

Examples of the aryl halide group as R⁶ include a 2-fluorophenyl group, a 3-fluorophenyl group, a 4-fluorophenyl group, a 2,4-difluorophenyl group, a 2,6-difluorophenyl group, a 3,4-difluorophenyl group, a 3,5-difluorophenyl group, a 2,4,6-trifluorophenyl group, a 3,4,5-trifluorophenyl group, a 2,3,5,6-tetrafluorophenyl group, a pentafluorophenyl group, a 2,3,5,6-tetrafluoro-4-trifluoromethylphenyl group, a 2,3,5,6-tetrafluoro-4-pentafluorophenylphenyl group, a perfluoro-1-naphthyl group, a perfluoro-2-naphthyl group, a 2-chlorophenyl group, a 3-chlorophenyl group, a 4-chlorophenyl group, a 2,4-dichlorophenyl group, a 2,6-dichlorophenyl group, a 3,4-dichlorophenyl group, a 3,5-dichlorophenyl group, a 2,4,6-trichlorophenyl group, a 3,4,5-trichlorophenyl group, a 2,3,5,6-tetrachlorophenyl group, a pentachlorophenyl group, a 2,3,5,6-tetrachloro-4-trichloromethylphenyl group, a 2,3,5,6-tetrachloro-4-pentachlorophenylphenyl group, a perchloro-1-naphthyl group, a perchloro-2-naphthyl group, a 2-bromophenyl group, a 3-bromophenyl group, a 4-bromophenyl group, a 2,4-dibromophenyl group, a 2,6-dibromophenyl group, a 3,4-dibromophenyl group, a 3,5-dibromophenyl group, a 2,4,6-tribromophenyl group, a 3,4,5-tribromophenyl group, a 2,3,5,6-tetrabromophenyl group, a pentabromophenyl group, a 2,3,5,6-tetrabromo-4-tribromomethylphenyl group, a 2,3,5,6-tetrabromo-4-pentabromophenylphenyl group, a perbromo-1-naphthyl group, a perbromo-2-naphthyl group, a 2-iodophenyl group, a 3-iodophenyl group, a 4-iodophenyl group, a 2,4-diiodophenyl group, a 2,6-diiodophenyl group, a 3,4-diiodophenyl group, a 3,5-diiodophenyl group, a 2,4,6-triiodophenyl group, a 3,4,5-triiodophenyl group, a 2,3,5,6-tetraiodophenyl group, a pentaiodophenyl group, a 2,3,5,6-tetraiodo-4-triiodomethylphenyl group, a 2,3,5,6-tetraiodo-4-pentaiodophenylphenyl group, a periodo-1-naphthyl group and a periodo-2-naphthyl group.

Examples of the (alkyl halide)aryl group as R⁶ include a 2-(trifluoromethyl)phenyl group, a 3-(trifluoromethyl)phenyl group, a 4-(trifluoromethyl)phenyl group, a 2,6-bis(trifluoromethyl)phenyl group, a 3,5-bis(trifluoromethyl)phenyl group, a 2,4,6-tris(trifluoromethyl)phenyl group and a 3,4,5-tris(trifluoromethyl)phenyl group.

Examples of the aryl cyanide group as R⁶ include a 2-cyanophenyl group, a 3-cyanophenyl group and a 4-cyanophenyl group.

Examples of the aryl nitride group as R⁶ include a 2-nitrophenyl group, a 3-nitrophenyl group and a 4-nitrophenyl group.

Examples of the hydrocarbyloxycarbonyl group as R⁶ include an alkoxycarbonyl group, an aralkyloxycarbonyl group and an aryloxycarbonyl group and more specifically include a methoxycarbonyl group, an ethoxycarbonyl group, a n-propoxycarbonyl group, an isopropoxycarbonyl group and a phenoxycarbonyl group.

Examples of the hydrocarbyloxycarbonyl halide group as R⁶ include an alkoxycarbonyl halide group, an aralkyloxycarbonyl halide group and an aryloxycarbonyl halide group and more specifically include a trifluoromethoxycarbonyl group and a pentafluorophenoxycarbonyl group.

R⁶ is preferably a hydrocarbyl halide group, more preferably an alkyl halide group or an aryl halide group, still more preferably an alkyl fluoride group, an aryl fluoride group, an alkyl chloride group or an aryl chloride group, particularly preferably an alkyl fluoride group or an aryl fluoride group. The alkyl fluoride group is preferably a fluoromethyl group, a difluoromethyl group, a trifluoromethyl group, a 2,2,2-trifluoroethyl group, a 2,2,3,3,3-pentafluoropropyl group, a 2,2,2-trifluoro-1-trifluoromethylethyl group or a 1,1-bis(trifluoromethyl)-2,2,2-trifluoroethyl group, more preferably a trifluoromethyl group, a 2,2,2-trifluoro-1-trifluoromethylethyl group or a 1,1-bis(trifluoromethyl)-2,2,2-trifluoroethyl group. The aryl fluoride group is preferably a 2-fluorophenyl group, a 3-fluorophenyl group, a 4-fluorophenyl group, a 2,4-difluorophenyl group, a 2,6-difluorophenyl group, a 3,4-difluorophenyl group, a 3,5-difluorophenyl group, a 2,4,6-trifluorophenyl group, a 3,4,5-trifluorophenyl group, a 2,3,5,6-tetrafluorophenyl group, a pentafluorophenyl group, a 2,3,5,6-tetrafluoro-4-trifluoromethylphenyl group, a 2,3,5,6-tetrafluoro-4-pentafluorophenylphenyl group, a perfluoro-1-naphthyl group or a perfluoro-2-naphthyl group, more preferably a 3,5-difluorophenyl group, a 3,4,5-trifluorophenyl group or a pentafluorophenyl group. The alkyl chloride group is preferably a chloromethyl group, a dichloromethyl group, a trichloromethyl group, a 2,2,2-trichloroethyl group, a 2,2,3,3,3-pentachloropropyl group, a 2,2,2-trichloro-1-trichloromethylethyl group or a 1,1-bis(trichloromethyl)-2,2,2-trichloroethyl group. The aryl chloride group is preferably a 4-chlorophenyl group, a 2,6-dichlorophenyl group, a 3.5-dichlorophenyl group, a 2,4,6-trichlorophenyl group, a 3,4,5-trichlorophenyl group or a pentachlorophenyl group.

R⁷ in the general formula (7) represents a hydrocarbyl group or a hydrocarbyl halide group. Examples of the hydrocarbyl group represented by R⁷ include an alkyl group, an aralkyl group and an aryl group and can include groups exemplified as the alkyl group, the aralkyl group and the aryl group represented by L. Examples of the hydrocarbyl halide group represented by R⁷ include hydrocarbyl halide groups such as an alkyl halide group, an aralkyl halide group, an aryl halide group and an (alkyl halide)aryl group and can include groups exemplified as the alkyl halide group, the aryl halide group and the (alkyl halide)aryl group represented by R⁶.

R⁷ is preferably a hydrocarbyl halide group, more preferably a hydrocarbyl fluoride group.

Examples of the compound represented by the general formula (5) as the component (b1) include compounds wherein M³ is a zinc atom, including: dialkylzinc such as dimethylzinc, diethylzinc, di-n-propylzinc, diisopropylzinc, di-n-butylzinc, diisobutylzinc and di-n-hexylzinc; diarylzinc such as diphenylzinc, dinaphthylzinc and bis(pentafluorophenyl)zinc; dialkenylzinc such as diallylzinc; bis(cyclopentadienyl)zinc; alkylzinc halide such as methylzinc chloride, ethylzinc chloride, n-propylzinc chloride, isopropylzinc chloride, n-butylzinc chloride, isobutylzinc chloride, n-hexylzinc chloride, methylzinc bromide, ethylzinc bromide, n-propylzinc bromide, isopropylzinc bromide, n-butylzinc bromide, isobutylzinc bromide, n-hexylzinc bromide, methylzinc iodide, ethylzinc iodide, n-propylzinc iodide, isopropylzinc iodide, n-butylzinc iodide, isobutylzinc iodide and n-hexylzinc iodide; and zinc halide such as zinc fluoride, zinc chloride, zinc bromide and zinc iodide.

The compound represented by the general formula (5) as the component (b1) is preferably dialkylzinc, more preferably dimethylzinc, diethylzinc, di-n-propylzinc, diisopropylzinc, di-n-butylzinc, diisobutylzinc or di-n-hexylzinc, particularly preferably dimethylzinc or diethylzinc.

Examples of the compound represented by the general formula (6) as the component (b2) include amine, phosphine, alcohol, thiol, phenol, thiophenol, naphthol, naphthylthiol and carboxylic acid compounds.

Examples of the amine can include di(fluoromethyl)amine, bis(difluoromethyl)amine, bis(trifluoromethyl)amine, bis(2,2,2-trifluoroethyl)amine, bis(2,2,3,3,3-pentafluoropropyl)amine, bis(2,2,2-trifluoro-1-trifluoromethylethyl)amine, bis(1,1-bis(trifluoromethyl)-2,2,2-trifluoroethyl)amine, bis(2-fluorophenyl)amine, bis(3-fluorophenyl)amine, bis(4-fluorophenyl)amine, bis(2,6-difluorophenyl)amine, bis(3,5-difluorophenyl)amine, bis(2,4,6-trifluorophenyl)amine, bis(3,4,5-trifluorophenyl)amine, bis(pentafluorophenyl)amine, bis(2-(trifluoromethyl)phenyl)amine, bis(3-(trifluoromethyl)phenyl)amine, bis(4-(trifluoromethyl)phenyl)amine, bis(2,6-di(trifluoromethyl)phenyl)amine, bis(3,5-di(trifluoromethyl)phenyl)amine, bis(2,4,6-tri(trifluoromethyl)phenyl)amine, bis(2-cyanophenyl)amine, (3-cyanophenyl)amine, bis(4-cyanophenyl)amine, bis(2-nitrophenyl)amine, bis(3-nitrophenyl)amine, bis(4-nitrophenyl)amine, bis(1H,1H-perfluorobutyl)amine, bis(1H,1H-perfluoropentyl)amine, bis(1H,1H-perfluorohexyl)amine, bis(1H,1H-perfluorooctyl)amine, bis(1H,1H-perfluorododecyl)amine, bis(1H,1H-perfluoropentadecyl)amine and bis(1H,1H-perfluoroeicosyl)amine. Alternative examples thereof can include amines in which fluoro in these amines is changed to chloro, bromo or iodo.

Examples of the phosphine can include compounds in which the nitrogen atom in the amines is changed to a phosphorus atom. Such phosphine is a compound represented by replacing the term “amine” in the above-described amines with the term “phosphine”.

Examples of the alcohol can include fluoromethanol, difluoromethanol, trifluoromethanol, 2,2,2-trifluoroethanol, 2,2,3,3,3-pentafluoropropanol, 2,2,2-trifluoro-1-trifluoromethylethanol, 1,1-bis(trifluoromethyl)-2,2,2-trifluoroethanol, 1H,1H-perfluorobutanol, 1H,1H-perfluoropentanol, 1H,1H-perfluorohexanol, 1H,1H-perfluorooctanol, 1H,1H-perfluorododecanol, 1H,1H-perfluoropentadecanol and 1H,1H-perfluoroeicosanol. Alternative examples thereof can include alcohols in which fluoro in these alcohols is changed to chloro, bromo or iodo.

Examples of the thiol can include compounds in which the oxygen atom in the alcohols is changed to a sulfur atom. Such thiol is a compound represented by replacing the term “nol” in the above-described alcohols with the term “nethiol”.

Examples of the phenol can include 2-fluorophenol, 3-fluorophenol, 4-fluorophenol, 2,4-difluorophenol, 2,6-difluorophenol, 3,4-difluorophenol, 3,5-difluorophenol, 2,4,6-trifluorophenol, 3,4,5-trifluorophenol, 2,3,5,6-tetrafluorophenol, pentafluorophenol, 2,3,5,6-tetrafluoro-4-trifluoromethylphenol and 2,3,5,6-tetrafluoro-4-pentafluorophenylphenol. Alternative examples thereof can include phenols in which fluoro in these phenols is changed to chloro, bromo or iodo.

Examples of the thiophenol can include compounds in which the oxygen atom in the phenols is changed to a sulfur atom. Such thiophenol is a compound represented by replacing the term “phenol” in the above-described phenols with the term “thiophenol”.

Examples of the naphthol can include perfluoro-1-naphthol, perfluoro-2-naphthol, 4,5,6,7,8-pentafluoro-2-naphthol, 2-(trifluoromethyl)phenol, 3-(trifluoromethyl)phenol, 4-(trifluoromethyl)phenol, 2,6-bis(trifluoromethyl)phenol, 3,5-bis(trifluoromethyl)phenol, 2,4,6-tris(trifluoromethyl)phenol, 2-cyanophenol, 3-cyanophenol, 4-cyanophenol, 2-nitrophenol, 3-nitrophenol and 4-nitrophenol. Alternative examples thereof can include naphthols in which fluoro in these naphthols is changed to chloro, bromo or iodo.

Examples of the naphthylthiol can include compounds in which the oxygen atom in the naphthols is changed to a sulfur atom. Such naphthylthiol is a compound represented by replacing the term “naphthol” in the above-described naphthols with the term “naphthylthiol”.

Examples of the carboxylic acid compounds can include pentafluorobenzoic acid, perfluoroethanoic acid, perfluoropropanoic acid, perfluorobutanoic acid, perfluoropentanoic acid, perfluorohexanoic acid, perfluoroheptanoic acid, perfluorooctanoic acid, perfluorononanoic acid, perfluorodecanoic acid, perfluoroundecanoic acid and perfluorododecanoic acid.

The compound represented by the general formula (6) as the component (b2) is preferably an amine, alcohol or phenol compound. The amine is preferably bis(trifluoromethyl)amine, bis(2,2,2-trifluoroethyl)amine, bis(2,2,3,3,3-pentafluoropropyl)amine, bis(2,2,2-trifluoro-1-trifluoromethylethyl)amine, bis(1,1-bis(trifluoromethyl)-2,2,2-trifluoroethyl)amine or bis(pentafluorophenyl)amine. The alcohol is preferably trifluoromethanol, 2,2,2-trifluoroethanol, 2,2,3,3,3-pentafluoropropanol, 2,2,2-trifluoro-1-trifluoromethylethanol or 1,1-bis(trifluoromethyl)-2,2,2-trifluoroethanol. The phenol is preferably 2-fluorophenol, 3-fluorophenol, 4-fluorophenol, 2,6-difluorophenol, 3,5-difluorophenol, 2,4,6-trifluorophenol, 3,4,5-trifluorophenol, pentafluorophenol, 2-(trifluoromethyl)phenol, 3-(trifluoromethyl)phenol, 4-(trifluoromethyl)phenol, 2,6-bis(trifluoromethyl)phenol, 3,5-bis(trifluoromethyl)phenol, 2,4,6-tris(trifluoromethyl)phenol or 3,4,5-tris(trifluoromethyl)phenol.

The compound represented by the general formula (6) as the component (b2) is more preferably bis(trifluoromethyl)amine, bis(pentafluorophenyl)amine, trifluoromethanol, 2,2,2-trifluoro-1-trifluoromethylethanol, 1,1-bis(trifluoromethyl)-2,2,2-trifluoroethanol, 2-fluorophenol, 3-fluorophenol, 4-fluorophenol, 2,6-difluorophenol, 3,5-difluorophenol, 2,4,6-trifluorophenol, 3,4,5-trifluorophenol, pentafluorophenol, 4-(trifluoromethyl)phenol, 2,6-bis(trifluoromethyl)phenol or 2,4,6-tris(trifluoromethyl)phenol, still more preferably, 3,5-difluorophenol, 3,4,5-trifluorophenol, pentafluorophenol or 1,1-bis(trifluoromethyl)-2,2,2-trifluoroethanol.

Examples of the compound represented by the general formula (7) as the component (b3) can include water, hydrogen sulfide, amine and aniline compounds.

Examples of the amine include: alkylamine such as methylamine, ethylamine, n-propylamine, isopropylamine, n-butylamine, sec-butylamine, tert-butylamine, isobutylamine, n-pentylamine, neopentylamine, isopentylamine, n-hexylamine, n-octylamine, n-decylamine, n-dodecylamine, n-pentadecylamine and n-eicosylamine; aralkylamine such as benzylamine, (2-methylphenyl)methylamine, (3-methylphenyl)methylamine, (4-methylphenyl)methylamine, (2,3-dimethylphenyl)methylamine, (2,4-dimethylphenyl)methylamine, (2,5-dimethylphenyl)methylamine, (2,6-dimethylphenyl)methylamine, (3,4-dimethylphenyl)methylamine, (3,5-dimethylphenyl)methylamine, (2,3,4-trimethylphenyl)methylamine, (2,3,5-trimethylphenyl)methylamine, (2,3,6-trimethylphenyl)methylamine, (3,4,5-trimethylphenyl)methylamine, (2,4,6-trimethylphenyl)methylamine, (2,3,4,5-tetramethylphenyl)methylamine, (2,3,4,6-tetramethylphenyl)methylamine, (2,3,5,6-tetramethylphenyl)methylamine, (pentamethylphenyl)methylamine, (ethylphenyl)methylamine, (n-propylphenyl)methylamine, (isopropylphenyl)methylamine, (n-butylphenyl)methylamine, (sec-butylphenyl)methylamine, (tert-butylphenyl)methylamine, (n-pentylphenyl)methylamine, (neopentylphenyl)methylamine, (n-hexylphenyl)methylamine, (n-octylphenyl)methylamine, (n-decylphenyl)methylamine, (n-tetradecylphenyl)methylamine, naphthylmethylamine and anthracenylmethylamine; allylamine; and cyclopentadienylamine.

Moreover, examples of the amine include alkylamine halide such as fluoromethylamine, difluoromethylamine, trifluoromethylamine, 2,2,2-trifluoroethylamine, 2,2,3,3,3-pentafluoropropylamine, 2,2,2-trifluoro-1-trifluoromethylethylamine, 1,1-bis(trifluoromethyl)-2,2,2-trifluoroethylamine, perfluoropropylamine, perfluorobutylamine, perfluoropentylamine, perfluorohexylamine, perfluorooctylamine, perfluorododecylamine, perfluoropentadecylamine and perfluoroeicosylamine. Alternative examples thereof can include amines in which fluoro in these amines is changed to chloro, bromo or iodo.

Examples of the aniline compounds can include aniline, naphthylamine, anthracenylamine, 2-methylaniline, 3-methylaniline, 4-methylaniline, 2,3-dimethylaniline, 2,4-dimethylaniline, 2,5-dimethylaniline, 2,6-dimethylaniline, 3,4-dimethylaniline, 3,5-dimethylaniline, 2,3,4-trimethylaniline, 2,3,5-trimethylaniline, 2,3,6-trimethylaniline, 2,4,6-trimethylaniline, 3,4,5-trimethylaniline, 2,3,4,5-tetramethylaniline, 2,3,4,6-tetramethylaniline, 2,3,5,6-tetramethylaniline, pentamethylaniline, 2-ethylaniline, 3-ethylaniline, 4-ethylaniline, 2,3-diethylaniline, 2,4-diethylaniline, 2,5-diethylaniline, 2,6-diethylaniline, 3,4-diethylaniline, 3,5-diethylaniline, 2,3,4-triethylaniline, 2,3,5-triethylaniline, 2,3,6-triethylaniline, 2,4,6-triethylaniline, 3,4,5-triethylaniline, 2,3,4,5-tetraethylaniline, 2,3,4,6-tetraethylaniline, 2,3,5,6-tetraethylaniline and pentaethylaniline. Alternative examples thereof include aniline compounds in which ethyl in these aniline compounds is changed to n-propyl, isopropyl, n-butyl, sec-butyl, tert-butyl, n-pentyl, neopentyl, n-hexyl, n-octyl, n-decyl, n-dodecyl, n-tetradecyl, or the like.

Moreover, examples of the aniline compounds can include 2-fluoroaniline, 3-fluoroaniline, 4-fluoroaniline, 2,6-difluoroaniline, 3,5-difluoroaniline, 2,4,6-trifluoroaniline, 3,4,5-trifluoroaniline, pentafluoroaniline, 2-(trifluoromethyl)aniline, 3-(trifluoromethyl)aniline, 4-(trifluoromethyl)aniline, 2,6-di(trifluoromethyl)aniline, 3,5-di(trifluoromethyl)aniline, 2,4,6-tri(trifluoromethyl)aniline and 3,4,5-tri(trifluoromethyl)aniline. Alternative examples thereof can include aniline compounds in which fluoro in these aniline compounds is changed to chloro, bromo, iodo, or the like.

The compound represented by the general formula (7) as the component (b3) is preferably water, hydrogen sulfide, methylamine, ethylamine, n-propylamine, isopropylamine, n-butylamine, sec-butylamine, tert-butylamine, isobutylamine, n-octylamine, aniline, 2,6-dimethylaniline, 2,4,6-trimethylaniline, naphthylamine, anthracenylamine, benzylamine, trifluoromethylamine, pentafluoroethylamine, perfluoropropylamine, perfluorobutylamine, perfluoropentylamine, perfluorohexylamine, perfluorooctylamine, perfluorododecylamine, perfluoropentadecylamine, perfluoroeicosylamine, 2-fluoroaniline, 3-fluoroaniline, 4-fluoroaniline, 2,6-difluoroaniline, 3,5-difluoroaniline, 2,4,6-trifluoroaniline, 3,4,5-trifluoroaniline, pentafluoroaniline, 2-(trifluoromethyl)aniline, 3-(trifluoromethyl)aniline, 4-(trifluoromethyl)aniline, 2,6-bis(trifluoromethyl)aniline, 3,5-bis(trifluoromethyl)aniline, 2,4,6-tris(trifluoromethyl)aniline or 3,4,5-tris(trifluoromethyl)aniline, particularly preferably water, trifluoromethylamine, perfluorobutylamine, perfluorooctylamine, perfluoropentadecylamine, 2-fluoroaniline, 3-fluoroaniline, 4-fluoroaniline, 2,6-difluoroaniline, 3,5-difluoroaniline, 2,4,6-trifluoroaniline, 3,4,5-trifluoroaniline, pentafluoroaniline, 2-(trifluoromethyl)aniline, 3-(trifluoromethyl)aniline, 4-(trifluoromethyl)aniline, 2,6-bis(trifluoromethyl)aniline, 3,5-bis(trifluoromethyl)aniline, 2,4,6-tris(trifluoromethyl)aniline or 3,4,5-tris(trifluoromethyl)aniline, most preferably water or pentafluoroaniline.

A solid substance that is insoluble in a solvent for preparation of the polymerization catalyst or a polymerization solvent is preferably used as the granular carrier as the component (b4). A porous substance is more preferably used. An inorganic substance or an organic polymer is still more preferably used, and the inorganic substance is particularly preferably used.

It is preferable that the granular carrier as the component (b4) have a uniform particle size. The volume-based geometric standard deviation of the particle sizes of the granular carrier as the component (b4) is preferably 2.5 or less, more preferably 2.0 or less, still more preferably 1.7 or less.

Examples of the inorganic substance used as the granular carrier as the component (b4) can include inorganic oxide, clay and clay mineral. Moreover, two or more of these inorganic substances may be mixed for use.

Examples of the inorganic oxide can include SiO₂, Al₂O₃, MgO, ZrO₂, TiO₂, B₂O₃, CaO, ZnO, BaO, ThO₂, SiO₂—MgO, SiO₂—Al₂O₃, SiO₂—TiO₂, SiO₂—V₂O₅, SiO₂—Cr₂O₃, SiO₂—TiO₂—MgO and mixtures of two or more thereof. Among these inorganic oxides, SiO₂ and/or Al₂O₃ are preferable, and particularly, SiO₂ (silica) is preferable. The inorganic oxide may contain a small amount of a carbonate, sulfate, nitrate or oxide component such as Na₂CO₃, K₂CO₃, CaCO₃, MgCO₃, Na₂SO₄, Al₂(SO₄)₃, BaSO₄, KNO₃, Mg(NO₃)₂, Al(NO₃)₃, Na₂O, K₂O or Li₂O.

Moreover, inorganic oxide usually contains hydroxy groups formed on the surface. Modified inorganic oxide in which the active hydrogen atoms of the surface hydroxy groups are substituted by various substituents may be used as the inorganic oxide. Examples of the modified inorganic oxide can include inorganic oxide brought into contact with trialkylchlorosilane such as trimethylchlorosilane and tert-butyldimethylchlorosilane; triarylchlorosilane such as triphenylchlorosilane; dialkyldichlorosilane such as dimethyldichlorosilane; diaryldichlorosilane such as diphenyldichlorosilane; alkyltrichlorosilane such as methyltrichlorosilane; aryltrichlorosilane such as phenyltrichlorosilane; trialkylalkoxysilane such as trimethylmethoxysilane; triarylalkoxysilane such as triphenylmethoxysilane; dialkyldialkoxysilane such as dimethyldimethoxysilane; diaryldialkoxysilane such as diphenyldimethoxysilane; alkyltrialkoxysilane such as methyltrimethoxysilane; aryltrialkoxysilane such as phenyltrimethoxysilane; tetraalkoxysilane such as tetramethoxysilane; alkyldisilazane such as 1,1,1,3,3,3-hexamethyldisilazane; tetrachlorosilane; alcohol such as methanol and ethanol; phenol; dialkylmagnesium such as dibutylmagnesium, butylethylmagnesium and butyloctylmagnesium; or alkyllithium such as butyllithium.

Further examples thereof can include inorganic oxide brought into contact with trialkylaluminum and then brought into contact with dialkylamine such as diethylamine and diphenylamine, alcohol such as methanol and ethanol or phenol.

Moreover, some inorganic oxides themselves have strength enhanced by the hydrogen bond between the hydroxy groups. In such a case, particle strength may be reduced, if all the active hydrogen atoms of the surface hydroxy groups are substituted by various substituents. Accordingly, it is not necessarily required to substitute all the active hydrogen atoms of the surface hydroxy groups in the inorganic oxide. The rate of substitution of the surface hydroxy groups can be determined appropriately. A method for changing the rate of substitution of the surface hydroxy groups is not particularly limited. Examples of the method can include a method comprising changing the amounts of the compounds used in the contact.

Examples of the clay or the clay mineral can include kaolin, bentonite, kibushi clay, gairome clay, allophane, hisingerite, pyrophyllite, talc, micas, smectite, montmorillonites, hectorite, Laponite, saponite, vermiculite, chlorites, palygorskite, kaolinite, nacrite, dickite and halloysite. Among them, smectite, montmorillonite, hectorite, Laponite or saponite is preferable. Montmorillonite or hectorite is more preferable.

Inorganic oxide is preferably used as the inorganic substance. It is preferable that the inorganic substance be dried such that the inorganic substance is substantially free from moisture. An inorganic substance dried by heat treatment is preferable. The heat treatment is usually carried out at a temperature of 100 to 1,500° C., preferably 100 to 1,000° C., and still more preferably 200 to 800° C. for an inorganic substance in which moisture cannot be confirmed by visual observation. The heating time is preferably 10 minutes to 50 hours, more preferably 1 hour to 30 hours. Examples of methods for the drying by heating can include a method which involves drying by the circulation of dry inert gas (e.g., nitrogen or argon) at a constant flow rate during heating and a method which involves heating and pressure reduction under reduced pressure.

The average particle size of the inorganic substance is usually 1 to 5,000 μm, preferably 5 to 1,000 μm, more preferably 10 to 500 μm, and still more preferably 10 to 100 μm. Its pore volume is preferably 0.1 ml/g or more, and more preferably 0.3 to 10 ml/g. Its specific surface area is preferably 10 to 1,000 m²/g, and more preferably 100 to 500 m²/g.

The organic polymer used as the granular carrier as the component (b4) is preferably a polymer having a functional group having active hydrogen or a non-proton-donating Lewis basic functional group.

Examples of the functional group having active hydrogen include a primary amino group, a secondary amino group, an imino group, an amide group, a hydrazide group, an amidino group, a hydroxy group, a hydroperoxy group, a carboxyl group, a formyl group, a carbamoyl group, a sulfonic acid group, a sulfinic acid group, a sulfenic acid group, a thiol group, a thioformyl group, a pyrrolyl group, an imidazolyl group, a piperidyl group, an indazolyl group and a carbazolyl group. The functional group having active hydrogen is preferably a primary amino group, a secondary amino group, an imino group, an amide group, an imide group, a hydroxy group, a formyl group, a carboxyl group, a sulfonic acid group or a thiol group. It is particularly preferably a primary amino group, a secondary amino group, an amide group or a hydroxy group. These groups may be substituted by a halogen atom or a hydrocarbyl group having 1 to 20 carbon atoms.

The non-proton-donating Lewis basic functional group is a functional group having a Lewis basic moiety free from an active hydrogen atom. Examples thereof include a pyridyl group, a N-substituted imidazolyl group, a N-substituted indazolyl group, a nitrile group, an azide group, a N-substituted imino group, an N,N-substituted amino group, an N,N-substituted aminooxy group, an N,N,N-substituted hydrazino group, a nitroso group, a nitro group, a nitroxy group, a furyl group, a carbonyl group, a thiocarbonyl group, an alkoxy group, an alkyloxycarbonyl group, an N,N-substituted carbamoyl group, a thioalkoxy group, a substituted sulfinyl group, a substituted sulfonyl group and a substituted sulfonic acid group. The non-proton-donating Lewis basic functional group is preferably a heterocyclic group, more preferably an aromatic heterocyclic group having an oxygen atom and/or a nitrogen atom in the ring. It is particularly preferably a pyridyl group, a N-substituted imidazolyl group or a N-substituted indazolyl group, and most preferably a pyridyl group. These groups may be substituted by a halogen atom or a hydrocarbyl group having 1 to 20 carbon atoms.

The content of the functional group having active hydrogen or the non-proton-donating Lewis basic functional group in the organic polymer is preferably 0.01 to 50 mmol/g, more preferably 0.1 to 20 mmol/g, in terms of the molar quantity of the functional group per polymer unit gram constituting the organic polymer.

Examples of methods for producing the polymer having the functional group having active hydrogen or the non-proton-donating Lewis basic functional group can include a method comprising homopolymerizing monomers having the functional group having active hydrogen or the non-proton-donating Lewis basic functional group and one or more polymerizable unsaturated group(s), and a method comprising copolymerizing the monomers with other monomers having polymerizable unsaturated group(s). In this method, it is preferable that even cross-linking polymerizable monomers having two or more polymerizable unsaturated groups be further copolymerized therewith.

Examples of the polymerizable unsaturated groups can include: alkenyl groups such as a vinyl group and an allyl group; and alkynyl groups such as an ethyne group.

Examples of the monomers having the functional group having active hydrogen and one or more polymerizable unsaturated group(s) can include vinyl group-containing primary amine, vinyl group-containing secondary amine, vinyl group-containing amide compounds and vinyl group-containing hydroxy compounds. Specific examples of the monomers include N-(1-ethenyl)amine, N-(2-propenyl)amine, N-(1-ethenyl)-N-methylamine, N-(2-propenyl)-N-methylamine, 1-ethenylamide, 2-propenylamide, N-methyl-(1-ethenyl)amide, N-methyl-(2-propenyl)amide, vinyl alcohol, 2-propen-1-ol and 3-buten-1-ol.

Examples of monomers having the functional group having a Lewis basic moiety free from an active hydrogen atom and one or more polymerizable unsaturated group(s) can include vinylpyridine, vinyl (N-substituted) imidazole and vinyl (N-substituted) indazole.

Examples of the other monomers having polymerizable unsaturated group(s) can include ethylene, an α-olefin, an aromatic vinyl compounds and a cyclic olefin. Specific examples of the monomers include ethylene, propylene, 1-butene, 1-hexene, 4-methyl-1-pentene, styrene, norbornene and dicyclopentadiene. Two or more of these monomers may be used. Ethylene or styrene is preferable. Moreover, examples of the cross-linking polymerizable monomers having two or more polymerizable unsaturated groups can include divinylbenzene.

The average particle size of the organic polymer is usually 1 to 5,000 μm, preferably 5 to 1,000 μm, and more preferably 10 to 500 μm. Its pore volume is preferably 0.1 ml/g or more, and more preferably 0.3 to 10 ml/g. Its specific surface area is preferably 10 to 1000 m²/g, and more preferably 50 to 500 m²/g.

It is preferable that the organic polymer be dried such that the organic polymer is substantially free from moisture. An organic polymer dried by heat treatment is preferable. The temperature of the heat treatment is usually 30 to 400° C., preferably 50 to 200° C., more preferably 70 to 150° C. for an organic polymer in which moisture cannot be confirmed by visual observation. The heating time is preferably 10 minutes to 50 hours, and more preferably 1 hour to 30 hours. Examples of methods for the drying by heating can include a method which involves drying by the circulation of dry inert gas (e.g., nitrogen or argon) at a constant flow rate during heating and a method which involves drying by heating under reduced pressure.

The promoter component (B) is obtained by bringing the components (b1), (b2), (b3) and (b4) into contact with each other. Examples of the order in which the components (b1), (b2), (b3) and (b4) are brought into contact with each other include the following orders: <1> the component (b1) is brought into contact with the component (b2), the contacted product obtained by the first contact is brought into contact with the component (b3), and the contacted product obtained by the second contact is brought into contact with the component (b4); <2> the component (b1) is brought into concact with the component (b2), the contacted product obtained by the first contact is brought into contact with the component (b4), and the contacted product obtained by the second contact is brought into contact with the component (b3); <3> the component (b1) is brought into contact with the component (b3), the contacted product obtained by the first contact is brought into contact with the component (b2), and the contacted product obtained by the second contact is brought into contact with the component (b4); <4> the component (b1) is brought into contact with the component (b3), the contacted product obtained by the first contact is brought into contact with the component (b4), and the contacted product obtained by the second contact is brought into contact with the component (b2); <5> the component (b1) is brought into contact with the component (b4), the contacted product obtained by the first contact is brought into contact with the component (b2), and the contacted product obtained by the second contact is brought into contact with the component (b3); <6> the component (b1) is brought into contact with the component (b4), the contacted product obtained by the first contact is brought into contact with the component (b3), and the contacted product obtained by the second contact is brought into contact with the component (b2); <7> the component (b2) is brought into contact with the component (b3), the contacted product obtained by the first contact is brought into contact with the component (b1), and the contacted product obtained by the second contact is brought into contact with the component (b4); <8> the component (b2) is brought into contact with the component (b3), the contacted product obtained by the first contact is brought into contact with the component (b4), and the contacted product obtained by the second contact is brought into contactt with the component (b1); <9> the component (b2) is brought into contact with the component (b4), the contacted product obtained by the first contact is brought into contact with the component (b1), and the contacted product obtained by the second contact is brought into contact with the component (b3); <10> the component (b2) is brought into contact with the component (b4), the contacted product obtained by the first contact is brought into contact with the component (b3), and the contacted product obtained by the second contact is brought into contact with the component (b1); <11> the component (b3) is brought into contact with the component (b4), the contacted product obtained by the first contact is brought into contact with the component (b1), and the contacted product obtained by the second contact is brought into contact with the component (b2); and <12> the component (b3) is brought into contact with the component (b4), the contacted product obtained by the first contact is brought into contact with the component (b2), and the contacted product obtained by the second contact is brought into contact with the component (b1).

It is preferable that the contact among the components (b1), (b2), (b3) and (b4) be carried out in an inert gas atmosphere. The contacting temperature is usually −100 to +300° C., and preferably −80 to +200° C. The contacting time is usually 1 minute to 200 hours, preferably 10 minutes to 100 hours. Moreover, a solvent may be used in the contact. Alternatively, these compounds may be brought into contact with each other directly without the use of a solvent.

When a solvent is used, the solvent that is unreactive with the components (b1), (b2), (b3) and (b4) and the contacted product thereof is used. However, when each component is brought into contact with each other stepwise as described above, any solvent that is reactive with a certain component at a certain stage, but is unreactive with the other components at the other stages can be used at the other stages. Specifically, a solvent to be used at each stage is the same as or different from the other solvents to be used at the other stages. Examples of such solvents can include: nonpolar solvents such as aliphatic hydrocarbon solvents and aromatic hydrocarbon solvents; and polar solvents such as halide solvents, ether solvents, alcoholic solvents, phenolic solvents, carbonyl solvents, phosphoric acid derivatives, nitrile solvents, nitro compounds, amine solvents and sulfur compounds. Specific examples thereof can include: aliphatic hydrocarbon solvents such as butane, pentane, hexane, heptane, octane, 2,2,4-trimethylpentane and cyclohexane; aromatic hydrocarbon solvents such as benzene, toluene and xylene; halide solvents such as dichloromethane, difluoromethane, chloroform, 1,2-dichloroethane, 1,2-dibromoethane, 1,1,2-trichloro-1,2,2-trifluoroethane, tetrachloroethylene, chlorobenzene, bromobenzene and o-dichlorobenzene; ether solvents such as dimethyl ether, diethyl ether, diisopropyl ether, di-n-butyl ether, methyl-tert-butyl-ether, anisole, 1,4-dioxane, 1,2-dimethoxyethane, bis(2-methoxyethyl)ether, tetrahydrofuran and tetrahydropyran; alcoholic solvents such as methanol, ethanol, 1-propanol, 2-propanol, 1-butanol, 2-butanol, 2-methyl-1-propanol, 3-methyl-1-butanol, cyclohexanol, benzyl alcohol, ethylene glycol, propylene glycol, 2-methoxyethanol, 2-ethoxyethanol, diethylene glycol, triethylene glycol and glycerin; phenolic solvents such as phenol and p-cresol; carbonyl solvents such as acetone, ethyl methyl ketone, cyclohexanone, acetic anhydride, ethyl acetate, butyl acetate, ethylene carbonate, propylene carbonate, N,N-dimethylformamide, N,N-dimethylacetamide and N-methyl-2-pyrrolidone; phosphoric acid derivatives such as hexamethylphosphoric acid triamide and triethyl phosphate; nitrile solvents such as acetonitrile, propionitrile, succinonitrile and benzonitrile; nitro compounds such as nitromethane and nitrobenzene; amine solvents such as pyridine, piperidine and morpholine; and sulfur compounds such as dimethyl sulfoxide and sulfolane.

The aliphatic hydrocarbon solvents, the aromatic hydrocarbon solvents or the ether solvents are preferable as a solvent (s1) for producing a contacted product (c), when the contacted product (c) obtained by the contact among the components (b1), (b2) and (b3) is brought into contact with the component (b4), specifically, in each of the methods <1>, <3> and <7>.

On the other hand, a polar solvent is preferable as a solvent (s2) to be used when the contacted product (c) is brought into contact with the component (b4). For example, E_{T}^{N} values (C. Reichardt, “Solvents and Solvents Effects in Organic Chemistry”, 2nd ed., VCH Verlag (1988).) are known as an index for the polarity of solvents. A solvent that satisfies the range of 0.8≧E_{T}^{N}≧0.1 is particularly preferable.

Examples of such polar solvents can include dichloromethane, dichlorodifluoromethanechloroform, 1,2-dichloroethane, 1,2-dibromoethane, 1,1,2-trichloro-1,2,2-trifluoroethane, tetrachloroethylene, chlorobenzene, bromobenzene, o-dichlorobenzene, dimethyl ether, diethyl ether, diisopropyl ether, di-n-butyl ether, methyl-tert-butyl ether, anisole, 1,4-dioxane, 1,2-dimethoxyethane, bis(2-methoxyethyl)ether, tetrahydrofuran, tetrahydropyran, methanol, ethanol, 1-propanol, 2-propanol, 1-butanol, 2-butanol, 2-methyl-1-propanol, 3-methyl-1-butanol, cyclohexanol, benzyl alcohol, ethylene glycol, propylene glycol, 2-methoxyethanol, 2-ethoxyethanol, diethylene glycol, triethylene glycol, acetone, ethyl methyl ketone, cyclohexanone, acetic anhydride, ethyl acetate, butyl acetate, ethylene carbonate, propylene carbonate, N,N-dimethylformamide, N,N-dimethylacetamide, N-methyl-2-pyrrolidone, hexamethylphosphoric acid triamide, triethyl phosphate, acetonitrile, propionitrile, succinonitrile, benzonitrile, nitromethane, nitrobenzene, ethylenediamine, pyridine, piperidine, morpholine, dimethyl sulfoxide and sulfolane.

The solvent (s2) is more preferably dimethyl ether, diethyl ether, diisopropyl ether, di-n-butyl ether, methyl-tert-butyl ether, anisole, 1,4-dioxane, 1,2-dimethoxyethane, bis(2-methoxyethyl)ether, tetrahydrofuran, tetrahydropyran, methanol, ethanol, 1-propanol, 2-propanol, 1-butanol, 2-butanol, 2-methyl-1-propanol, 3-methyl-1-butanol, cyclohexanol, benzyl alcohol, ethylene glycol, propylene glycol, 2-methoxyethanol, 2-ethoxyethanol, diethylene glycol or triethylene glycol, particularly preferably di-n-butyl ether, methyl-tert-butyl ether, 1,4-dioxane, tetrahydrofuran, methanol, ethanol, 1-propanol, 2-propanol, 1-butanol, 2-butanol, 2-methyl-1-propanol, 3-methyl-1-butanol or cyclohexanol, most preferably tetrahydrofuran, methanol, ethanol, 1-propanol or 2-propanol.

A mixed solvent of any of these polar solvents and a hydrocarbon solvent can be used as the solvent (s2). Any compound exemplified as the aliphatic hydrocarbon solvents or the aromatic hydrocarbon solvents is used as the hydrocarbon solvent. Examples of the mixed solvent of the polar solvent and the hydrocarbon solvent can include a hexane/methanol mixed solvent, a hexane/ethanol mixed solvent, a hexane/1-propanol mixed solvent, a hexane/2-propanol mixed solvent, a heptane/methanol mixed solvent, a heptane/ethanol mixed solvent, a heptane/1-propanol mixed solvent, a heptane/2-propanol mixed solvent, a toluene/methanol mixed solvent, a toluene/ethanol mixed solvent, a toluene/1-propanol mixed solvent, a toluene/2-propanol mixed solvent, a xylene/methanol mixed solvent, a xylene/ethanol mixed solvent, a xylene/1-propanol mixed solvent and a xylene/2-propanol mixed solvent. The mixed solvent is preferably a hexane/methanol mixed solvent, a hexane/ethanol mixed solvent, a heptane/methanol mixed solvent, a heptane/ethanol mixed solvent, a toluene/methanol mixed solvent, a toluene/ethanol mixed solvent, a xylene/methanol mixed solvent or a xylene/ethanol mixed solvent. It is more preferably a hexane/methanol mixed solvent, a hexane/ethanol mixed solvent, a toluene/methanol mixed solvent or a toluene/ethanol mixed solvent. It is most preferably a toluene/ethanol mixed solvent. Moreover, the ethanol fraction in the toluene/ethanol mixed solvent is preferably in the range of 10 to 50% by volume, more preferably 15 to 30% by volume.

When the contacted product (c) obtained by the contact among the components (b1), (b2) and (b3) is brought into contact with the component (b4), specifically, in each of the methods <1>, <3> and <7>, hydrocarbon solvents may be used as both the solvents (s1) and (s2). In this case, a shorter time from the contact among the components (b1), (b2) and (b3) to the contact between the obtained contacted product (c) and the component (b4) is preferable. The time is preferably 0 to 5 hours, more preferably 0 to 3 hours, most preferably 0 to 1 hour. Moreover, the temperature of the contact between the contacted product (c) and the component (b4) is usually −100° C. to 40° C., preferably −20° C. to +20° C., most preferably −10° C. to +10° C.

In the method <2>, <5>, <6>, <8>, <9>, <10>, <11> or <12>, any of the nonpolar solvents and polar solvents can be used. The nonpolar solvent is preferable. This is because the contacted product between the components (b1) and (b3), or the contacted product obtained by the contact of the component (b3) with the contacted product between the components (b1) and (b2) is generally poor in solubility to the nonpolar solvent; thus, when the component (b4) is present in a reaction system in which the contacted product is formed, this contacted product may be separated on the surface of the component (b4) and immobilized more easily.

It is preferable that the amounts of the components (b2) and (b3) to be used per mole of the amount of the component (b1) to be used satisfy the following inequality:

|Valence of M³−molar quantity of component (b2)−2×molar quantity of component (b3)≦1 (III)

Moreover, the amount of the component (b2) to be used per mole of the amount of the component (b1) to be used is preferably 0.01 to 1.99 moles, more preferably 0.1 to 1.8 moles, still more preferably 0.2 to 1.5 moles, most preferably 0.3 to 1 mole. The preferable, more preferable, still more preferable, and most preferable amounts of the component (b3) to be used per mole of the amount of the component (b1) to be used are calculated according to the valence of M³, the amount of the component (b2) to be used per mole of the amount of the component (b1) to be used, and the inequality (III), respectively.

The amounts of the components (b1) and (b2) to be used are amounts in which the amount of metal atoms derived from the component (b1) contained in the promoter component (B) is preferably 0.1 mmol or more, more preferably 0.5 to 20 mmol, expressed by the molar number of the metal atoms contained per gram of the promoter component (B).

After the contact as described above, a heating step at a higher temperature may be added to the method for allowing reaction to proceed more rapidly. In the heating step, a solvent having a higher boiling point is preferably used for achieving the higher temperature. The solvent used in the contact may be replaced with the other solvent having a higher boiling point when the heating step is carried out.

As a result of such contact, the components (b1), (b2), (b3) and/or (b4) as starting materials may remain as unreacted products in the promoter component (B). However, it is preferable that washing treatment be performed in advance to remove the unreacted products. In this washing treatment, a solvent may be the same as or different from the solvent used in the contact. It is preferable that such washing treatment be carried out in an inert gas atmosphere. The contacting temperature is usually −100 to +300° C., and preferably −80 to +200° C. The contacting time is usually 1 minute to 200 hours, and preferably 10 minutes to 100 hours.

Moreover, it is preferable that after such contact or washing treatment, the solvent be distilled off from the product, which is then dried under reduced pressure at a temperature of 0° C. or higher for 1 hour to 24 hours, more preferably at a temperature of 0° C. to 200° C. for 1 hour to 24 hours, still more preferably at a temperature of 10° C. to 200° C. for 1 hour to 24 hours, particularly preferably at a temperature of 10° C. to 160° C. for 2 hours to 18 hours, most preferably at a temperature of 15° C. to 160° C. for 4 hours to 18 hours.

Examples of the production of the ethylene-α-olefin copolymer of the present invention can include a method comprising copolymerizing ethylene with an α-olefin in the presence of a polymerization catalyst obtained by bringing a transition metal compound (A1) represented by the general formula (1), a transition metal compound (A2) represented by the general formula (3) and a promoter component (B) into contact with each other.

The molar ratio ((A1)/(A2)) of the transition metal compound (A1) to the transition metal compound (A2) is preferably 1 to 10, and more preferably 1.5 to 5.

The total amount of the transition metal compound (A1) and the transition metal compound (A2) to be used is usually 1 to 10.000 mmol/g, preferably 10 to 1.000 mmol/g, and more preferably 20 to 500 mmol/g, per gram of the promoter component (B).

In the preparation of the polymerization catalyst, an organic aluminum compound (C) may be further brought into contact with the transition metal compound (A1), the transition metal compound (A2) and the promoter component (B). The amount of the organic aluminum compound (C) used is preferably 0.1 to 1,000, more preferably 0.5 to 500, and still more preferably 1 to 100, expressed by the molar number of aluminum atoms in the organic aluminum compound (C) per mole as the total molar number of the transition metal compound (A1) and the transition metal compound (A2).

Examples of the organic aluminum compound (C) can include: trialkylaluminum such as trimethylaluminum, triethylaluminum, tri-n-propylaluminum, tri-n-butylaluminum, triisobutylaluminum, tri-n-hexylaluminum and tri-n-octylaluminum; dialkylaluminum chloride such as dimethylaluminum chloride, diethylaluminum chloride, di-n-propylaluminum chloride, di-n-butylaluminum chloride, diisobutylaluminum chloride and di-n-hexylaluminum chloride; alkylaluminum dichloride such as methylaluminum dichloride, ethylaluminum dichloride, n-propylaluminum dichloride, n-butylaluminum dichloride, isobutylaluminum dichloride and n-hexylaluminum dichloride; dialkylaluminum hydride such as dimethylaluminum hydride, diethylaluminum hydride, di-n-propylaluminum hydride, di-n-butylaluminum hydride, diisobutylaluminum hydride and di-n-hexylaluminum hydride; alkyl(dialkoxy)aluminum such as methyl(dimethoxy)aluminum, methyl(diethoxy)aluminum and methyl(di-tert-butoxy)aluminum; dialkyl(alkoxy)aluminum such as dimethyl(methoxy)aluminum, dimethyl(ethoxy)aluminum and methyl(tert-butoxy)aluminum; alkyl(diaryloxy)aluminum such as methyl(diphenoxy)aluminum, methylbis(2,6-diisopropylphenoxy)aluminum and methylbis(2,6-diphenylphenoxy)aluminum; and dialkyl(aryloxy)aluminum such as dimethyl(phenoxy)aluminum, dimethyl(2,6-diisopropylphenoxy)aluminum and dimethyl(2,6-diphenylphenoxy)aluminum. These organic aluminum compounds may be used alone or in combination of two or more thereof.

The organic aluminum compound (C) is preferably trialkylaluminum, more preferably trimethylaluminum, triethylaluminum, tri-n-butylaluminum, triisobutylaluminum, tri-n-hexylaluminum or tri-n-octylaluminum, still more preferably triisobutylaluminum or tri-n-octylaluminum.

Moreover, in the preparation of the polymerization catalyst, an electron-donating compound (D) may be further brought into contact with the transition metal compound (A1), the transition metal compound (A2) and the promoter component (B). The amount of the electron-donating compound (D) to be used is preferably 0.01 to 100, more preferably 0.1 to 50, and still more preferably 0.25 to 5, expressed by the molar number of the electron-donating compound (D) per mole as the total molar number of the transition metal compound (A1) and the transition metal compound (A2).

Examples of the electron-donating compound (D) can include triethylamine and tri-normal-octylamine.

It is preferable that the contact among the transition metal compound (A1), the transition metal compound (A2) and the promoter component (B), and optionally, the organic aluminum compound (C) and the electron-donating compound (D) be carried out in an inert gas atmosphere. The contacting temperature is usually −100 to +300° C., preferably −80 to +200° C. The contacting time is usually 1 minute to 200 hours, preferably 30 minutes to 100 hours. Moreover, the contact may be performed in a polymerization reactor by separately adding the components to the polymerization reaction vessel.

Examples of methods for producing the ethylene-α-olefin copolymer of the present invention include methods comprising copolymerizing ethylene with an α-olefin by a gas-phase polymerization method, a slurry polymerization method, a bulk polymerization method, or the like. The gas-phase polymerization method is preferable, and a continuous gas-phase polymerization method is more preferable. A gas-phase polymerization reactor used in the polymerization method is usually an apparatus having a fluidized-bed reaction vessel, preferably an apparatus having a fluidized-bed reaction vessel with an enlarged part. A stirring blade may be disposed in the reaction vessel.

A method comprising supplying the polymerization catalyst or each component in a moisture-free state using an inert gas (e.g., nitrogen or argon), hydrogen, ethylene, or the like, or a method comprising dissolving or diluting each component in a solvent and supplying the obtained solution or slurry is usually used as a method for supplying the polymerization catalyst and each catalyst component to the polymerization reaction vessel.

When ethylene and an α-olefin are polymerized in a gas phase, the polymerization temperature is usually lower than a temperature at which the ethylene-α-olefin copolymer is melted, preferably 0 to 150° C., more preferably 30 to 100° C. An inert gas may be introduced into the polymerization reaction vessel, and hydrogen may be introduced thereinto as a molecular weight regulator. Moreover, the organic aluminum compound (C) or the electron-donating compound (D) may be introduced thereinto.

Examples of the α-olefin to be used in the polymerization include α-olefins having 3 to 20 carbon atoms, such as propylene, 1-butene, 1-pentene, 1-hexene, 1-heptene, 1-octene, 1-nonene, 1-decene, 1-dodecene, 4-methyl-1-pentene and 4-methyl-1-hexene. They may be used alone or in combination of two or more thereof. The α-olefin is preferably 1-butene, 1-hexene, 4-methyl-1-pentene or 1-octene. Examples of the combination of ethylene and an α-olefin include ethylene/1-butene, ethylene/1-hexene, ethylene/4-methyl-1-pentene, ethylene/1-octene, ethylene/1-butene/1-hexene, ethylene/1-butene/4-methyl-1-pentene, ethylene/1-butene/1-octene and ethylene/1-hexene/1-octene. The combination is preferably ethylene/1-hexene, ethylene/4-methyl-1-pentene, ethylene/1-butene/1-hexene, ethylene/1-butene/1-octene or ethylene/1-hexene/1-octene.

Moreover, in the copolymerization of ethylene with an α-olefin, an other monomers may be introduced, if necessary, into the polymerization reaction vessel and copolymerized without impairing the effect of the present invention. Examples of the other monomers can include diolefins, cyclic olefins, alkenyl-aromatic hydrocarbons and α,β-unsaturated carboxylic acids.

Specific examples thereof include: diolefins such as 1,5-hexadiene, 1,4-hexadiene, 1,4-pentadiene, 1,7-octadiene, 1,8-nonadiene, 1,9-decadiene, 4-methyl-1,4-hexadiene, 5-methyl-1,4-hexadiene, 7-methyl-1,6-octadiene, 5-ethylidene-2-norbornene, dicyclopentadiene, 5-vinyl-2-norbornene, 5-methyl-2-norbornene, norbornadiene, 5-methylene-2-norbornene, 1,5-cyclooctadiene, 5,8-endomethylenehexahydronaphthalene, 1,3-butadiene, isoprene, 1,3-hexadiene, 1,3-octadiene, 1,3-cyclooctadiene and 1,3-cyclohexadiene; cyclic olefins such as norbornene, 5-methylnorbornene, 5-ethylnorbornene, 5-butylnorbornene, 5-phenylnorbornene, 5-benzylnorbornene, tetracyclododecene, tricyclodecene, tricycloundecene, pentacyclopentadecene, pentacyclohexadecene, 8-methyltetracyclododecene, 8-ethyltetracyclododecene, 5-acetylnorbornene, 5-acetyloxynorbornene, 5-methoxycarbonylnorbornene, 5-ethoxycarbonylnorbornene, 5-methyl-5-methoxycarbonylnorbornene, 5-cyanonorbornene, 8-methoxycarbonyltetracyclododecene, 8-methyl-8-tetracyclododecene and 8-cyanotetracyclododecene; alkenyl-aromatic hydrocarbons, for example, alkenylbenzene such as styrene, 2-phenylpropylene, 2-phenylbutene and 3-phenylpropylene, alkylstyrene such as p-methylstyrene, m-methylstyrene, o-methylstyrene, p-ethylstyrene, m-ethylstyrene, o-ethylstyrene, 2,4-dimethylstyrene, 2,5-dimethylstyrene, 3,4-dimethylstyrene, 3,5-dimethylstyrene, 3-methyl-5-ethylstyrene, p-tert-butylstyrene and p-sec-butylstyrene, bisalkenylbenzene such as divinylbenzene, and alkenylnaphthalene such as 1-vinylnaphthalene; α,β-unsaturated carboxylic acids such as acrylic acid, methacrylic acid, fumaric acid, maleic anhydride, itaconic acid, itaconic anhydride and bicyclo(2,2,1)-5-heptene-2,3-dicarboxylic acid; metal (e.g., sodium, potassium, lithium, zinc, magnesium or calcium) salts of the α,β-unsaturated carboxylic acids; α,β-unsaturated carboxylic acid alkyl ester such as methyl acrylate, ethyl acrylate, n-propyl acrylate, isopropyl acrylate, t-butyl acrylate, 2-ethylhexyl acrylate, methyl methacrylate, ethyl methacrylate, n-propyl methacrylate, isopropyl methacrylate, n-butyl methacrylate and isobutyl methacrylate; unsaturated dicarboxylic acids such as maleic acid and itaconic acid; vinyl esters such as vinyl acetate, vinyl propionate, vinyl caproate, vinyl caprate, vinyl laurate, vinyl stearate and vinyl trifluoroacetate; and unsaturated carboxylic acid glycidyl esters such as glycidyl acrylate, glycidyl methacrylate and itaconic acid monoglycidyl ester.

The method for producing the ethylene-α-olefin copolymer of the present invention is preferably a method comprising: polymerizing a small amount of an olefin using the transition metal compound (A1), the transition metal compound (A2) and the promoter component (B) and optionally further using the organic aluminum compound (C) and the electron-donating compound (D) (hereinafter, this step is referred to as prepolymerization); and using the obtained prepolymerized solid component as a polymerization catalyst component or a polymerization catalyst to copolymerize ethylene with an α-olefin.

Examples of the olefin to be used in the prepolymerization can include ethylene, propylene, 1-butene, 1-pentene, 1-hexene, 1-octene, 4-methyl-1-pentene, cyclopentene and cyclohexene. They may be used alone or in combination of two or more thereof. Preferably, only ethylene or the combination of ethylene and an α-olefin, more preferably, only ethylene or the combination of ethylene and at least one α-olefin selected from 1-butene, 1-hexene and 1-octene, is used.

The content of the prepolymerized polymer in the prepolymerized solid component is preferably 0.01 to 1,000 g, more preferably 0.05 to 500 g, still more preferably 0.1 to 200 g, per gram of the promoter component (B).

A method for the prepolymerization may be a continuous polymerization or batch polymerization method and is, for example, a batch slurry polymerization, continuous slurry polymerization, or continuous gas-phase polymerization method. A method comprising adding each component in a moisture-free state using an inert gas (e.g., nitrogen or argon), hydrogen, ethylene, or the like, or a method comprising dissolving or diluting each component in a solvent and adding the obtained solution or slurry is usually used as a method for adding the transition metal compound (A1), the transition metal compound (A2) and the promoter component (B), and optionally, the organic aluminum compound (C) and the electron-donating compound (D) to the polymerization reaction vessel for performing prepolymerization.

When the prepolymerization is performed by the slurry polymerization method, a saturated aliphatic hydrocarbon compound is usually used as a solvent. Examples thereof include propane, normal butane, isobutane, normal pentane, isopentane, normal hexane, cyclohexane and heptane. These solvents are used alone or in combination of two or more thereof. It is preferable that the saturated aliphatic hydrocarbon compound have a boiling point of 100° C. or lower at ordinary pressure, and more preferably a boiling point of 90° C. or lower at normal pressure. The saturated aliphatic hydrocarbon compound is still more preferably propane, normal butane, isobutane, normal pentane, isopentane, normal hexane or cyclohexane.

Moreover, when the prepolymerization is performed by the slurry polymerization method, the concentration of the slurry is usually 0.1 to 600 g, preferably 0.5 to 300 g, in terms of the amount of the promoter component (B) per liter of the solvent. The prepolymerization temperature is usually −20 to +100° C., and preferably 0 to +80° C. The polymerization temperature may be changed appropriately during prepolymerization. However, a temperature at the start of prepolymerization is set to preferably 45° C. or lower, and more preferably 40° C. or lower. Moreover, the partial pressure of olefins in the gas-phase part during prepolymerization is usually 0.001 to 2 MPa, and preferably 0.01 to 1 MPa. The prepolymerization time is usually 2 minutes to 15 hours.

A method comprising supplying each component in a moisture-free state using an inert gas (e.g., nitrogen or argon), hydrogen, ethylene, or the like, or a method comprising dissolving or diluting each component in a solvent and supplying the obtained solution or slurry is usually used as a method for supplying the prepolymerized solid catalyst component obtained by the prepolymerization to the polymerization reaction vessel.

The resin composition for cross-linking expansion molding of the present invention comprises a resin component comprising the ethylene-α-olefin copolymer described above, a foaming agent and a cross-linking agent.

Examples of the foaming agent that may be used in the present invention can include thermally decomposable foaming agents having a decomposition temperature equal to or higher than the melting temperature of the resin component. Examples thereof can include azodicarbonamide, barium azodicarboxylate, azobisbutyronitrile, nitrodiguanidine, N,N-dinitrosopentamethylenetetramine, N,N′-dimethyl-N,N′-dinitrosoterephthalamide, P-toluenesulfonyl hydrazide, P,P′-oxybis(benzenesulfonyl hydrazide)azobisisobutyronitrile, P,P′-oxybis(benzenesulfonyl semicarbazide), 5-phenyltetrazole, trihydrazinotriazine and hydrazodicarbonamide. These foaming agents are used alone or in combination of two or more thereof. Among them, azodicarbonamide or sodium bicarbonate is preferable. Moreover, it is preferable that the resin composition for cross-linking expansion molding of the present invention comprise 100 parts by weight of the resin component and 0.5 to 50 parts by weight, more preferably 1 to 20 parts by weight, and still more preferably 1 to 15 parts by weight of the foaming agent relative to 100 parts by weight of the resin component.

The resin composition for cross-linking expansion molding according to the present invention may optionally comprise a foaming aid. Examples of the foaming aid include: compounds composed mainly of urea; metal oxides such as zinc oxide and lead oxide; higher fatty acids such as salicylic acid and stearic acid; and metal compounds of the higher fatty acids. The amount of the foaming aid used is preferably 0.1 to 30% by weight, and more preferably 1 to 20% by weight, relative to 100% by weight in total of the foaming agent and the foaming aid.

Organic peroxide having a decomposition temperature equal to or higher than the temperature at which the resin component contained in the resin composition for cross-linking expansion molding starts to flow is preferably used as the cross-linking agent used in the present invention. Examples thereof can include dicumyl peroxide, 1,1-di-tert-butylperoxy-3,3,5-trimethylcyclohexane, 2,5-dimethyl-2,5-di-tert-butylperoxyhexane, 2,5-dimethyl-2,5-di-tert-butylperoxyhexyne, α,α-di-tert-butyl peroxyisopropyl benzene, tert-butyl peroxyketone and tert-butyl peroxybenzoate. The proportion of the cross-linking agent contained in the resin composition is usually 0.02 to 3 parts by weight, and preferably 0.05 to 1.5 parts by weight, relative to 100 parts by weight in total of the resin component.

The resin composition for cross-linking expansion molding of the present invention may comprise various additives such as heat stabilizers, weather-resistant agents, lubricants, antistatic agents, fillers and pigments (metal oxides such as zinc oxide, titanium oxide, calcium oxide, magnesium oxide and silicon oxide; carbonates such as magnesium carbonate and calcium carbonate; fibrous materials such as pulp, etc.). Moreover, the resin composition may comprise, as a resin component, a resin or a rubber such as an ethylene-unsaturated ester copolymer, high-density polyethylene, polypropylene or polybutene, in addition to the ethylene-α-olefin copolymer that satisfies all the conditions (1) to (5) described above. Particularly, when the cross-linked expansion molded article of the present invention or a compressed cross-linked expansion molded article described later is used in a shoe sole or a shoe sole member, it is often required to bond it to other members such as a rubber or a PVC sheet. Thus, it is preferable that the resin composition comprise an ethylene-unsaturated ester copolymer such as an ethylene-vinyl acetate copolymer. When the resin composition for cross-linking expansion molding of the present invention comprises an ethylene-unsaturated ester copolymer, its content is preferably 25 to 900 parts by weight, and more preferably 40 to 400 parts by weight, relative to 100 parts by weight of the ethylene-α-olefin copolymer that satisfies the conditions (1) to (5).

The resin composition for cross-linking expansion molding of the present invention is preferably used in the production of the cross-linked expansion molded article. Examples of methods for producing the cross-linked expansion molded article using the resin composition for cross-linking expansion molding include a method comprising: melt-mixing the resin component, the cross-linking agent and the foaming agent using a mixing roll, a kneader, an extruder, or the like, at a temperature at which neither the foaming agent nor the cross-linking agent is decomposed; filling the obtained resin composition for cross-linking expansion molding into a mold using an injection molding machine or the like; foaming the resin composition in a pressurized (dwelt)/heated state, followed by cooling; and recovering the cross-linked expansion molded article, and a method comprising: placing, in a mold, the composition for cross-linking expansion molding obtained by the melt-mixing; foaming the composition in a pressurized (dwelt)/heated state using a pressurizing press or the like, followed by cooling; and recovering the cross-linked expansion molded article.

The cross-linked expansion molded article can be obtained by filling the resin composition for cross-linking expansion molding of the present invention into a mold and cross-linking foaming the resin composition by heating under pressure of 50 kg/cm² or more at a temperature that is equal to or higher than the decomposition temperature of the foaming agent and equal to or higher than the decomposition temperature of the cross-linking agent. The mold clamping pressure is preferably 50 to 300 kgf/cm². The dwelling time is preferably approximately 10 to 60 minutes.

The cross-linked expansion molded article obtained by the method described above may further be compression molded into a compressed cross-linked expansion molded article. The compression molding is usually performed under conditions involving 130 to 200° C. for 5 to 60 minutes under application of a load of 30 to 200 kg/cm². The compressed cross-linked expansion molded article of the present invention is more suitable for a midsole, a kind of footwear member.

The cross-linked expansion molded article or the compressed cross-linked expansion molded article of the present invention may be used by cutting into a desired shape or may be used by buffing.

The cross-linked expansion molded article or the compressed cross-linked expansion molded article of the present invention may be layered with an other layer to form a multilayered article. Examples of materials constituting the other layer include vinyl chloride resin materials, styrene copolymer rubber materials, olefin copolymer rubber materials (ethylene copolymer rubber materials, propylene copolymer rubber materials, etc.), natural leather materials, artificial leather materials and cloth materials. At least one of these materials is used.

Examples of methods for producing such a multilayered article include a method comprising attaching the cross-linked expansion molded article or the compressed cross-linked expansion molded article of the present invention to the separately molded other layer by thermal attaching or using a chemical adhesive or the like. Any of those known in the art can be used as the chemical adhesive. Among them, particularly, a urethane or chloroprene chemical adhesive or the like is preferable. Moreover, a primer may be applied beforehand for the bonding using such a chemical adhesive.

The cross-linked expansion molded article and the compressed cross-linked expansion molded article of the present invention exhibit favorable fatigue resistance. Therefore, the cross-linked expansion molded article and the compressed cross-linked expansion molded article of the present invention can be used preferably in a monolayered or multilayered form as, for example, a member for footwear such as shoes and sandals. Examples of the footwear member include midsoles, outer soles and insoles. Moreover, the cross-linked expansion molded article and the compressed cross-linked expansion molded article of the present invention is also used in, for example, construction materials such as heat insulators and buffers, in addition to the footwear member.

### EXAMPLES

Hereinafter, the present invention will be described more specifically with reference to Examples and Comparative Examples.

(1) Melt Flow Rate (MFR, Unit: g/10 min)

The MFR was measured by the A method according to JIS K7210-1995 under conditions involving a temperature of 190° C. and a load of 21.18 N.

(2) Density (Unit: kg/m³)

The density was measured according to the immersion method prescribed in JIS K7112-1980 after annealing prescribed in JIS K6760-1995.

### (3) Melt Flow Rate Ratio (MFRR)

The value was determined by measuring a melt flow rate (H-MFR) by the method prescribed in JIS K7210-1995 under conditions involving a test load of 211.82 N and a measurement temperature of 190° C., and a melt flow rate (MFR) by the method prescribed in JIS K7210-1995 under conditions involving a load of 21.18 N and a temperature of 190° C., and dividing the H-MFR by the MFR.

(4) Activation Energy of Flow (Ea, Unit: kJ/mol)

The activation energy (Ea) was determined by measuring kinetic viscosity-angular frequency curves at 130° C., 150° C., 170° C. and 190° C. using a viscoelasticity measurement apparatus (Rheometrics Mechanical Spectrometer RMS-800 manufactured by Rheometrics, Inc.) under the following measurement conditions and next determining Ea using calculation software Rhios V.4.4.4 manufactured by Rheometrics, Inc., from the obtained kinetic viscosity-angular velocity curves:

### <Measurement Conditions>

Geometry: parallel plate

Plate diameter: 25 mm

Plate space: 1.5 to 2 mm

Strain: 5%

Angular frequency: 0.1 to 100 rad/sec.

Measurement atmosphere: in a nitrogen atmosphere

### (5) Molecular Weight Distribution (Mw/Mn, Mz/Mw)

The Mw/Mn and the Mz/Mw were determined by measuring the z-average molecular weight (Mz), the weight-average molecular weight (Mw) and the number-average molecular weight (Mn) using gel permeation chromatography (GPC) under conditions (1) to (8) shown below. A baseline on the chromatogram was set to a line that was formed by linking a point in a stable horizontal region having a retention time sufficiently shorter than that at which the peak of an eluted sample appeared, to a point in a stable horizontal region having a retention time sufficiently longer than that at which the peak of an eluted solvent was observed.

(1) Apparatus: Waters 150C manufactured by Waters Corp.

(2) Separation column: TOSOH TSKgel GMH6-HT

(3) Measurement temperature: 140° C.

(4) Carrier: Orthodichlorobenzene

(5) Flow rate: 1.0 mL/min

(6) Injection amount: 500 μL

(7) Detector: Differential refractometer

(8) Molecular weight standard: Standard polystyrene

### (6) Melt Tension (MT, Unit: cN)

A tension required for drawing was measured using a melt tension tester manufactured by Toyo Seiki Seisaku-Sho, Ltd., by melt-extruding an ethylene-α-olefin copolymer from an orifice of 2.095 mm in diameter and 8 mm in length at a temperature of 190° C. and an extrusion rate of 0.32 g/min, and drawing a filament form of the extruded melted ethylene-α-olefin copolymer at an upward drawing rate of 6.3 (m/min)/min using a drawing roll. The melt tension was set to the maximum tension in a period from the start of drawing to the break of the filament form of the ethylene-α-olefin copolymer.

(7) Specific Gravity of Cross-Linked Expansion Molded Article (Unit: kg/m³)

The specific gravity was measured according to ASTM-D297. The lower this value is, the more excellent lightness becomes.

### (8) Skin-Off Hardness of Cross-Linked Expansion Molded Article (Unit: None)

A 2-mm skin was peeled off from the foam surface (skin-on surface) of the obtained cross-linked expansion molded article using a food slicer (manufactured by NANTSUNE Co., Ltd., model HBC-2) to expose a foam section (skin-off surface). The hardness of this exposed foam section was measured according to ASTM-D2240 using a Type C durometer.

### (9) Compression Set of Cross-Linked Expansion Molded Article (Unit: %)

The obtained cross-linked pressurized foam was sliced into a thickness of 1 cm and then cut to obtain a sample of 2.5 cm×2.5 cm×1.0 cm. The sample was compressed to adjust the thickness from 1.0 cm to 5 mm. While being kept compressed, the sample was left for 6 hours in an oven adjusted to 50° C. After depressurization, the sample was left at room temperature for 30 minutes. Then, its thickness t [mm] was measured, and the compression set was determined according to the equation shown below. The measurement was carried out using four test pieces, and the average value was used as a measurement value. The smaller the value is, the higher the fatigue resistance.

Compression set (%)={(10−t)/(10−5)}×100

### Example 1

### Preparation of Ethylene-α-Olefin Copolymer (A1)

### (1) Preparation of Solid Catalyst Component

In a nitrogen-substituted reactor equipped with a stirrer, 2.8 kg of silica (Sylopol 948 manufactured by Grace Davison; 50% volume average particle size=55 μm; pore volume=1.67 ml/g; specific surface area=325 m²/g) heat-treated at 300° C. under nitrogen circulation, and 24 kg of toluene were added and stirred. Then, the reactor was cooled to 5° C., and a mixed solution of 0.9 kg of 1,1,1,3,3,3-hexamethyldisilazane and 1.4 kg of toluene was then added dropwise thereto over 30 minutes with the reactor temperature kept at 5° C. After the completion of dropwise addition, the mixture was stirred at 5° C. for 1 hour, subsequently heated to 95° C., and stirred at 95° C. for 3 hours, followed by filtration. The obtained solid product was washed with 20.8 kg of toluene 6 times. Then, 7.1 kg of toluene was added thereto to form slurry, which was then left standing overnight.

To the slurry thus obtained, 1.73 kg of a hexane solution of diethylzinc (diethylzinc concentration: 50% by weight) and 1.02 kg of hexane were added and stirred. Then, the reactor was cooled to 5° C., and a mixed solution of 0.78 kg of 3,4,5-trifluorophenol and 1.44 kg of toluene was then added dropwise thereto over 60 minutes with the reactor temperature kept at 5° C. After the completion of dropwise addition, the mixture was stirred at 5° C. for 1 hour, subsequently heated to 40° C., and stirred at 40° C. for 1 hour. Then, the reactor was cooled to 22° C., and 0.11 kg of H₂O was added dropwise thereto over 1.5 hours with the reactor temperature kept at 22° C. After the completion of dropwise addition, the mixture was stirred at 22° C. for 1.5 hours, subsequently heated to 40° C., stirred at 40° C. for 2 hours, further heated to 80° C., stirred at 80° C. for 2 hours. After the stirring, the supernatant was removed at room temperature until the remaining amount was 16 L. To the residue, 11.6 kg of toluene was added, and the mixture was subsequently heated to 95° C. and stirred for 4 hours. After the stirring, the supernatant was removed at room temperature to obtain a solid product. The obtained solid product was washed with 20.8 kg of toluene four times and 24 L of hexane three times. Then, a solid catalyst component was obtained by drying.

### (2) Polymerization

After drying under reduced pressure, a vacuum was produced in an argon-substituted 3-L autoclave equipped with a stirrer, and hydrogen was added thereto such that its partial pressure was 0.01 MPa. To the autoclave, 220 ml of 1-hexene and 650 g of butane as a polymerization solvent were added, and the autoclave was heated to 70° C. Then, ethylene was added thereto such that its partial pressure was 1.6 MPa to stabilize the system. As a result of gas chromatography analysis, the composition of gas in the system was hydrogen=0.8 mol %. To this system, 0.9 ml of a hexane solution of triisobutylaluminum adjusted to a concentration of 1 mol/l was added as an organic aluminum compound (C). Next, 0.3 ml of a toluene solution of racemic mixture of ethylene bis(1-indenyl)zirconium diphenoxide [corresponding to a transition metal compound (A1)] adjusted to a concentration of 2 μmol/ml, and 0.25 ml of a toluene solution of diphenylmethylene(cyclopentadienyl)(9-fluorenyl)zirconium dichloride [corresponding to a transition metal compound (A2)] adjusted to a concentration of 0.2 μmol/ml were added thereto, and 23.7 mg of the solid catalyst component obtained in the paragraph (1) was subsequently added thereto. Polymerization was performed at 70° C. for 30 minutes with ethylene/hydrogen mixed gas (hydrogen=0.25 mol %) continuously supplied such that the total pressure and the hydrogen concentration in the gas were kept constant during the polymerization. Then, butane, ethylene and hydrogen were purged to obtain 220 g of an ethylene-1-hexene copolymer. Similar polymerization was repeated 4 times to obtain a total of 712 g of an ethylene-1-hexene copolymer (A1). The obtained copolymers were kneaded using a roll for complete uniformity, and a portion thereof was used to evaluate physical properties. The physical properties of the copolymer obtained by kneading are shown in Table 1.

### (3) Expansion Molding

60 parts by weight of the ethylene-α-olefin copolymer (A1) and 40 parts by weight of an ethylene-vinyl acetate copolymer (COSMOTHENE H2181 manufactured by The Polyolefin Company [MFR=2 g/10 min, density=940 kg/m³, vinyl acetate unit amount=18% by weight]; hereinafter, referred to as EVA (1)) were kneaded with 10 parts by weight of heavy calcium carbonate, 1.0 part by weight of stearic acid, 1.0 part by weight of zinc oxide, 2.6 parts by weight of a thermally decomposable foaming agent (CELLMIC CE manufactured by SANKYO KASEI Co., Ltd.) and 0.7 parts by weight of dicumyl peroxide using a roll kneader under conditions involving a roll temperature of 120° C. and a kneading time of 5 minutes to obtain a resin composition for cross-linking expansion molding. The resin composition for cross-linking expansion molding was packed into a mold of 15 cm×15 cm×2.0 cm and expansion molded under conditions involving a temperature of 165° C., a time of 30 minutes and a pressure of 150 kg/cm² to obtain a cross-linked expansion molded article. Results of evaluating the physical properties of the obtained cross-linked expansion molded article are shown in Table 2.

### Comparative Example 1

### Preparation of Ethylene-α-Olefin Copolymer (A2)

### (1) Treatment of Silica

In a nitrogen-substituted reactor equipped with a stirrer, 24 kg of toluene as a solvent and 2.81 kg of silica as a fine granular carrier (a) (Sylopol 948 manufactured by Grace Davison; 50% average particle size=55 μm; pore volume=1.67 ml/g; specific surface area=325 m²/g) heat-treated at 300° C. under nitrogen circulation were placed and stirred. Then, the reactor was cooled to 5° C., and a mixed solution of 0.91 kg of 1,1,1,3,3,3-hexamethyldisilazane and 1.43 kg of toluene was then added dropwise thereto over 32 minutes with the reactor temperature kept at 5° C. After the completion of dropwise addition, the mixture was stirred at 5° C. for 1 hour and at 95° C. for 3.3 hours. Then, the obtained solid product was washed with 21 kg of toluene 6 times. Then, 7.1 kg of toluene was added thereto, and the resulting slurry was then left standing overnight.

### (2) Preparation of Solid Catalyst Component

To the toluene slurry obtained in Example 1(1), 1.75 kg of a hexane solution of 50 wt % diethylzinc as a compound (b), and 1.0 kg of hexane as a solvent were added and stirred. Then, the reactor was cooled to 5° C., and a mixed solution of 0.78 kg of trifluorophenol as a compound (c) and 1.41 kg of toluene as a solvent was then added dropwise thereto over 61 minutes with the reactor temperature kept at 5° C. After the completion of dropwise addition, the mixture was stirred at 5° C. for 1 hour and at 40° C. for 1 hour. Then, the reactor was cooled to 22° C., and 0.11 kg of water as a compound (d) was then added dropwise thereto over 1.5 hours with the reactor temperature kept at 5° C. After the completion of dropwise addition, the mixture was stirred at 22° C. for 1.5 hours, at 40° C. for 2 hours and further at 80° C. for 2 hours. After the completion of stirring, the supernatant was removed until the remaining amount was 16 L. To the residue, 11.6 kg of toluene was added and stirred. The mixture was heated to 95° C. and stirred for 4 hours. The obtained solid product was washed with 20.8 kg of toluene four times and 24 L of hexane three times. Then, a solid catalyst component (hereinafter, referred to as a promoter carrier (b)) was obtained by drying.

### (3) Preparation of Prepolymerized Catalyst Component (3)

To a nitrogen-substituted 210-L autoclave equipped with a stirrer, 80 L of butane was added, and 109 mmol of racemic mixture of ethylene bis(1-indenyl)zirconium diphenoxide was then added. The autoclave was heated to 50° C., and stirring was performed for 2 hours. Next, the autoclave was cooled to 30° C. to stabilize the system. Then, ethylene was added thereto, such that the gas phase pressure in the autoclave was 0.03 MPa. To the autoclave, 0.7 kg of the promoter carrier (b) was added, and 158 mmol of triisobutylaluminum was subsequently added to start polymerization. After a lapse of 30 minutes with ethylene continuously supplied at 0.7 kg/hr, the autoclave was heated to 50° C., while ethylene and hydrogen were continuously supplied at 3.5 kg/hr and 10.2 L (volume at room temperature and normal pressure)/hr, respectively, to carry out prepolymerization for a total of 4 hours. After the completion of polymerization, ethylene, butane, hydrogen gas, and the like were purged, and the remaining solid was vacuum-dried at room temperature to obtain a prepolymerized catalyst component (3) in which 15 g of polyethylene was prepolymerized per gram of the promoter carrier (a).

### (4) Production of Ethylene-α-Olefin Copolymer

Ethylene and 1-hexene were copolymerized in a continuous fluidized-bed gas-phase polymerization apparatus using the prepolymerized catalyst component (2) thus obtained to obtain polymer powder. The polymerization conditions involved a polymerization temperature of 80° C., a polymerization pressure of 2 MPa, a 0.4% molar ratio of hydrogen to ethylene and a 1.6% molar ratio of 1-hexene to the total of ethylene and 1-hexene. During polymerization, ethylene, 1-hexene and hydrogen were continuously supplied to keep the composition of gas constant. Moreover, the prepolymerized catalyst component and triisobutylaluminum were continuously supplied to keep the total powder weight (80 kg) of the fluidized bed constant. The average polymerization time was 4 hours. The obtained polymer powder was pelletized using an extruder (LCM50 manufactured by KOBE STEEL, LTD.) under conditions involving a feed rate of 50 kg/hr, the number of screw revolutions of 450 rpm, the degree of gate opening of 50%, a suction pressure of 0.1 MPa and a resin temperature of 200 to 230° C. to obtain an ethylene-α-olefin copolymer (A2). The physical properties of the obtained copolymer are shown in Table 1.

### (5) Expansion Molding

A cross-linked expansion molded article was obtained by repeating expansion molding in the same manner as in Example 1 except that the ethylene-α-olefin copolymer (A1) of Example 1 was changed to an ethylene-α-olefin copolymer (A2) and the amount of the thermally decomposable foaming agent was changed from 2.6 parts by weight to 2.2 parts by weight. Results of evaluating the physical properties of the obtained cross-linked expansion molded article are shown in Table 2.

### Comparative Example 2

### (1) Expansion Molding

A cross-linked expansion molded article was obtained by repeating expansion molding in the same manner as in Comparative Example 1 except that the amount of the thermally decomposable foaming agent of Comparative Example 1 was changed from 2.2 parts by weight to 3.3 parts by weight. Results of evaluating the physical properties of the obtained cross-linked expansion molded article are shown in Table 2.

### Comparative Example 3

### (1) Expansion Molding

A cross-linked expansion molded article was obtained by repeating expansion molding in the same manner as in Example 1 except that only EVA (1) was used as a resin component and the amount of the thermally decomposable foaming agent was changed from 2.6 parts by weight to 2.0 parts by weight. Results of evaluating the physical properties of the obtained cross-linked expansion molded article are shown in Table 3.

### Comparative Example 4

### (1) Expansion Molding

A cross-linked expansion molded article was obtained by repeating expansion molding in the same manner as in Comparative Example 3 except that the amount of the thermally decomposable foaming agent of Comparative Example 3 was changed from 2.0 parts by weight to 3.0 parts by weight. Results of evaluating the physical properties of the obtained cross-linked expansion molded article are shown in Table 3.

TABLE 1

| Ethylene-α-olefin copolymer | | A1 | A2 |
|---|---|---|---|
| Density | Kg/m³ | 915 | 912 |
| MFR | g/10 minutes | 0.46 | 0.51 |
| MFRR | — | 65.4 | 99.2 |
| Molecular weight distribution | | | |
| Mw/Mn | — | 7.9 | 8.7 |
| Mz/Mw | | 2.6 | 2.5 |
| SCB | /1000 C | 17.5 | 21.5 |
| [η] | | 1.26 | 1.1 |
| Activation energy of flow | kJ/mol | 79.2 | 79.5 |
| Melt tension | cN | 18.4 | 6.5 |

TABLE 2

| | | | Compar- | Compar- |
|---|---|---|---|---|
| | | Example | ative | ative |
| | | 1 | Example 1 | Example 2 |
| Composition of | | | | |
| resin | | | | |
| A1 | Part by weight | 60 | 0 | 0 |
| A2 | Part by weight | 0 | 0 | 0 |
| EVA1 | Part by weight | 40 | 60 | 60 |
| Thermally | Part by weight | 2.6 | 40 | 40 |
| decomposable | | | | |
| foaming agent | | | | |
| Physical properties | | | 2.2 | 3.3 |
| of cross-linked foam | | | | |
| Specific gravity | [kg/m³] | 204 | | |
| of foam | | | | |
| Skin-off hardness | [shoreC] | 54 | 167 | 105 |
| Compression set | [%] | 42 | 56 | 43 |
| | | | 61 | 68 |

TABLE 3

| | | Comparative | Comparative |
|---|---|---|---|
| | | Example 3 | Example 4 |
| Composition of resin | | | |
| A1 | Part by weight | 0 | 0 |
| A2 | Part by weight | 0 | 0 |
| A2 | Part by weight | 0 | 0 |
| EVA1 | Part by weight | 100 | 100 |
| Thermally decomposable | Part by weight | 2.0 | 3.0 |
| foaming agent | | | |
| Physical properties | | | |
| of cross-linked foam | | | |
| Specific gravity of foam | [kg/m³] | 179 | 114 |
| Skin-off hardness | [shoreC] | 52 | 40 |
| Compression set | [%] | 63 | 66 |

### INDUSTRIAL APPLICABILITY

The present invention can provide: a resin composition for cross-linking expansion molding that can be used to obtain a cross-linked expansion molded article having superior fatigue resistance; a cross-linked expansion molded article obtained by cross-linking expansion molding the resin composition; a compressed cross-linked expansion molded article obtained by compressing the cross-linked expansion molded article; a footwear member having a layer of the cross-linked expansion molded article or the compressed cross-linked expansion molded article; and footwear comprising the footwear member.

1. A resin composition for cross-linking expansion molding comprising a resin component, a foaming agent and a cross-linking agent, wherein the resin composition comprises, as the resin component, an ethylene-α-olefin copolymer that comprises monomer units derived from ethylene and monomer units derived from an α-olefin having 3 to 20 carbon atoms and that satisfies all the following conditions (1) to (5):
(1) the density is 860 to 950 kg/m³,
(2) the melt flow rate (MFR) is 0.01 to 10 g/10 min,
(3) the ratio of the weight-average molecular weight to the number-average molecular weight (Mw/Mn) is 5.5 to 30,
(4) the ratio of the z-average molecular weight to the weight-average molecular weight (Mz/Mw) is 2 to 4, and
(5) the melt tension (MT) is 8 cN or more.

2. The resin composition for cross-linking expansion molding according to claim 1, wherein the ethylene-α-olefin copolymer has an activation energy of flow (Ea) of 60 kJ/mol or more.

3. The resin composition for cross-linking expansion molding according to claim 1, wherein the resin composition comprises 100 parts by weight of the resin component and 0.5 to 50 parts by weight of the foaming agent relative to 100 parts by weight of the resin component.

4. A cross-linked expansion molded article obtained by cross-linking expansion molding the resin composition for cross-linking expansion molding according to claim 1.

5. A compressed cross-linked expansion molded article obtained by compressing the cross-linked expansion molded article according to claim 4.

6. A footwear member having a layer of the cross-linked expansion molded article according to claim 4.

7. A footwear member having a layer of the compressed cross-linked expansion molded article according to claim 5.

8. Footwear comprising the footwear member according to claim 6.
